(19) United States
(12) Patent Application Publication
(10) Pub. No.: US 2008/0044799 A1
(43) Pub. Date: Feb. 21, 2008

(54) Mind modeling method and apparatus

(76) Inventor: Sudhir Sitaram Krishna, Sunnyvale, CA (US)

Correspondence Address: Raj Abhyanker LLP;c/o Intellevate, P.O. Box 52050, Minneapolis, MN, 55402, US

(21) Appl. No.: 11/893,794

(22) Filed: Aug. 17, 2007

Related U.S. Application Data
(60) Provisional application No. 60/838,630, filed on Aug. 18, 2006.

(51) Int. Cl. G09B 19/00

(52) U.S. Cl. 434/236

(57) ABSTRACT

A mind modeling method and apparatus is disclosed. In one embodiment, a method of a personality test includes determining a set of mind layer attributes based on a library of categories, analyzing a set of a mind layer categories through a variable chosen from a group including a resistance to change variable and an intensity variable, evlauating the mind layer categories through the set of layers, and determining a variance of a category distribution of the set of layers. The method may further include generating a library of connotations which evolves based on a set of learnings, insights and thoughts, developing a library of stimuli tagged to individual layer categories and an origin of the stimuli based on the set of learnings, and mapping a stimulus to the layer and the origin through a random number generator.

### CLAIMS OF PRIORITY

This patent application claims priority from U.S. provisional patent application Ser. No. 60/838,630, titled ‘Computer model of ego and personality’ filed on Aug. 18, 2006.

### FIELD OF TECHNOLOGY

This disclosure relates generally to the technical fields of hardware and software, and in one embodiment, to a mind modeling method and apparatus.

### BACKGROUND

A human mind is complex and may function in myriad ways, having capabilities for insights, imagination, intuition, emotion, rational and irrational behavior, sanity and insanity, varying kinds of psychological disorders, biases, prejudices, likes and dislikes, fears and insecurities, hopes and aspirations, dreams and fantasies, etc.

Personality tests and psychological evaluations may attempt to analyze aspects of a person's mind by determining patterns of behavior, traits, specific characteristics, thoughts and/or feelings, etc. Some such evaluations may be manual in nature. For example, the person may take a physical test, an electronic test and/or may otherwise provide responses to queries of an administrator. The person's personality and/or psychological profile may be evaluated based on his/her responses and/or an analysis of the person's observed behavior.

Evaluations may also be at least partly automated through computerized analysis and/or data processing algorithms. For example, the use of computers to model the human mind (e.g., the study of “artificial intelligence”) may often be based on narrowing a search space for a computer (e.g., by employing heuristics) and using the power of calculation of the computer within the search space. For example, emulations and simulations based on psychological and/or cognitive data may be valuable analytical tools to researchers in sociology, psychology, education, anthropology, religion, business, marketing and/or organizational behavior, etc.

However, personality and psychological tests may not provide reliable and/or stable models of a person's mind and/or cognitive state. They may not account for factors that may influence and change the person's perceptions, behavior and response to stimuli in complex ways. For example, contextual, genetic, environmental and/or individual cognitive characteristics of a person's mind may confound analysis of the person's response to a stimulus, resulting in inferences about the person's behavior and/or characteristics that may not be valid or reliable.

In addition, the personality tests may not account for dynamically interactive and/or heterogeneous aspects of a single person's state of mind at any one time, and/or over a period of time. For example, the personality test may not capture variations in affect to stimuli based on permutations of genetic predispositions, experience, insights and/or learning, resulting in misleading and/or inaccurate evaluations of the person's behavior, traits or cognitive characteristics.

Furthermore, the psychological tests may provide inherently limited assessments of a person's state of mind (e.g., behavior, cognition, traits, etc.) with respect to other persons, groups, contextual environments and evolving dispositions (e.g., based on training, education, advertising, societal changes, economic circumstances, spiritual insight, etc.)

As such, personality test and psychological evaluations may be limited in their ability to reliability and/or stimulate behavior of individuals and groups and/or to provide insight into effects of changing certain variables, the relative importance of those variables, and/or specific actions that one might take to achieve desired results.

### SUMMARY OF THE DISCLOSURE

A mind modeling method and apparatus is disclosed. In one aspect, a method of a personality test includes determining a set of mind layer attributes based on a library of categories, analyzing a set of mind layer categories through at least one variable chosen from a group including a resistance to change variable and an intensity variable, evaluating the mind layer categories through at least one of the set of layers, and determining a variance of a category distribution of the set of layers.

The method may further include generating a library of connotations which evolves based on a set of learnings, insights and thoughts, developing a library of stimuli tagged to individual mind layer categories and an origin of the stimuli based on the set of learnings, mapping a stimulus to the layer and the origin through a random number generator, and when the random number generator determines a value lower than a threshold value, routing data to a truth and openness layer data of a processing module. A response to stimulus factors may include an insight, a learned training, an innate trait, an instinct, a talent and a skill, etc. The method may also include generating the variance through an algorithm that considers any of a random selection and a relative probability of a particular event occurring.

In addition, the method may include generating a response to the stimulus having an intensity and/or resistance through a macro entity pegged to an individual factor and/or a micro entity pegged to a personal experience factor. The method may yet include generating the response through an algorithm that considers a probabilistic and/or a deterministic response to the stimulus. The method may further include enhancing the stimulus through an addition of a factor determined by a user input.

The method may also include matching the stimulus with a response, and determining a connotation mapping and a connotation response mapping based on the stimulus. A response may be generated a back to the individual responsive to the connotation response mapping of an individual. A response may be generated back to a micro entity responsive to the connotation response mapping of the micro entity including a family, a community and an association. A response may be generated back to a macro entity responsive to the connotation response mapping of the macro entity including a geographic group, a social group and a civic body.

An exception variable may be provided of a stimulus from one entity response in a response to the individual, the micro entity and/or the macro entity. The method may further include generating a weighted score using a product of a layer weight and intensity through a computer simulation that generates a time period analysis of an effect of the stimuli having a summary of weighted responses that are at least one of a positive response and negative response. The method may include generating a change in a mind layer of the set of layers based on an insight gained, a knowledge gained, and a conditioning of an entity represented in the simulation.

The method may also include transforming a response of the entity represented through an iterative process that considers weights, response intensities and connotations to future stimuli. The simulation may be structured in a multi-layer model in which a highest layer includes a truth attribute having a lack of ego connotation and a power of transformation of the various mind layers of the individual, a layer adjacent to the highest layer includes talents, skills, a knowledge acquisition and expanding an intellectual capacity of a mind through an increase of certain responses and intensities in that layer, a set of other layers to modify the connotations of the mind through a resistance to a change which is incorporated through a threshold value, and to allow the change to occur when the random number exceeds the resistance to change.

In addition, the method may include a seven layer model generated through questioning mind, aesthetic sense, openness to new insights, change, compassion, and empathy in one layer, determining imagination, intuition, pattern recognition, memory, calculation, logic, music, math, and planning in another layer, analyzing likes and dislikes, memories of pleasure and pain, physical attributes, opinions, biases, interests, and mental problems in yet another layer, determining livelihood of profession, skills, position, economic status, education, money and investments, responsibilities, and authority in a further layer, generating a community layer having a set of laws, hierarchy, role, do's and don'ts, ideology, politics, social status, rights and obligations in yet a further layer, evaluating family and cultural bonds through an analysis of right and wrong, popular culture, religion, and beliefs in a next layer, and determining gender, lust, greed, fear, fight, flight, anger, desires, cunning, and race in yet a next layer.

The method may also include a series of responses and corresponding weighted scores of an individual mind, a group of minds, and a geographic region. The method may also include determining a set of patterns of experiences (e.g., may include a love variable, an anger variable, a revenge variable, an insight variable, and/or a compassion variable, etc.) that at least one of the individual mind, the group of minds, and the geographic region is having. In addition, the method may include determining a preference of a particular item through the set of patterns of experiences shared with at least one other entity. The method may further include reporting a trace of all changes of the individual mind due to insights, learnings and conditionings.

The method may include a network of individual representations to form a group and society having one including a sample size based on statistical analysis to obtain a desired confidence level, relying on the confidence level through the network of individual representations, placing the network of individual representations in a collective entity serving as a vessel of recording an aggregate effect of a set of responses of individual minds, and calibrating a set of assumptions until a set of results of a simulation are validated through a reality-checking analysis.

In another aspect, an apparatus includes a mind module to determine a set of mind layer attributes based on library of categories, an assessment module to determine a set of mind layer categories through at least one variable chosen from a group comprising a resistance to change variable and an intensity variable, an evaluation module to evaluate the set of layer categories through at least one of the set of layers, and a variance module to determine a variance of a category distribution of the set of layers through an algorithm that considers a relative probability of any particular event occurring.

The apparatus may further include a livelihood module to determine livelihood of profession, skills, position, economic status, education, money and investments, responsibilities, and authority in a further layer, a community module to generate a set of laws, hierarchy, role, do's and don'ts, ideology, politics, social status, rights and obligations in yet a further layer, a social hierarchy module to value family and cultural bonds through an analysis of right and wrong, popular culture, religion, and beliefs in a next layer; and an emotion module to determine gender, lust, greed, fear, fight, flight, anger, desires, cunning, and race in yet a next layer.

In yet another aspect, system includes a mind modeling module to generate a simulation of a mind structured in a multi-layer model in which a highest layer includes a truth attribute having a lack of ego connotation and a power of transformation of various mind layers of an individual, a layer adjacent to the highest layer includes talents, skills, a knowledge acquisition and/or expanding an intellectual capacity of a mind through an increase of certain responses and intensities in that layer, a set of other layers modify the connotations of the mind through a resistance to a change which is incorporated through a threshold value, and to allow the change to occur when the random number is greater than the resistance to change, a network, and a client module to generate a stimulus through a macro entity pegged to an individual factor and/or a micro entity pegged to a personal experience factor, match the stimulus with a response, and determine a connotation mapping and a connotation response mapping based on the stimulus.

The system may further include an instruction set to determine a set of patterns of experiences of an entity (e.g., may be an individual mind, a group of minds, a geographic group, a social group, a civic body, a nation and/or a global collective, etc.) represented through an iterative process that considers weights, response intensities and connotations to future stimuli.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate'similar elements and in which:

FIG. 1 is a system view of a mind modeling module and a client module communicating with various entity environments and/or individuals through a network, according to one embodiment.

FIG. 2 is an exploded view of the processing module of FIG. 1, according to one embodiment.

FIG. 3 is an exploded view of the client module of FIG. 1, according to one embodiment.

FIG. 4 is a system view of the mind modeling module of FIG. 1, according to one embodiment.

FIG. 5 is a layer framework of a multi-layer model of a human mind, according to one embodiment.

FIG. 6 is a flow diagram of a mind modeling algorithm of the processing module of FIG. 1, according to one embodiment.

FIG. 7 is a table view of the layer framework of FIG. 5 illustrating intensity and resistance to change variables of mind layer categories and subcategories, according to one embodiment.

FIG. 8 is a continuation of the table view of FIG. 7, illustrating intensity and resistance to change variables of additional mind layer categories and subcategories, according to one embodiment.

FIG. 9 is a table view of mind layers, connotations and responses corresponding to external stimuli, according to one embodiment.

FIG. 10 is a chart view illustrating categories, sub-categories, an intensity variable and a resistance to change variable associated with a micro entity and a macro entity, according to one embodiment.

FIG. 11 is a chart view illustrating the mind layers and responses associated with various stimulus types, according to one embodiment.

FIG. 12 is a network diagram of stimulus-response mappings between a macro entity, a micro entity and a network of individual representations, according to one embodiment.

FIG. 13 is a report view illustrating responses, weighted scores, feedback, and mind modifications generated based on the external stimuli, according to one embodiment.

FIG. 14 is a block diagram of a computerized mind modeling simulation, according to one embodiment.

FIG. 15 is a diagrammatic system view of a data processing system in which any of the embodiments disclosed herein may be performed, according to one embodiment.

FIG. 16A is a process flow of a method of a personality test, according to one embodiment.

FIG. 16B is a continuation of the process flow of FIG. 16A, according to one embodiment.

FIG. 16C is a continuation of the process flow of FIG. 16B, according to one embodiment.

FIG. 16D is a continuation of the process flow of FIG. 16C, according to one embodiment.

Other features of the present embodiments will be apparent from the accompanying drawings and from the detailed description that follows.

### DETAILED DESCRIPTION

A mind modeling method and apparatus are disclosed. In the following description, for the purposes of explanation, numerous specific details are set forth in order to provide a thorough understanding of the various embodiments. It will be evident, however, to one skilled in the art that the various embodiments may be practiced without these specific details.

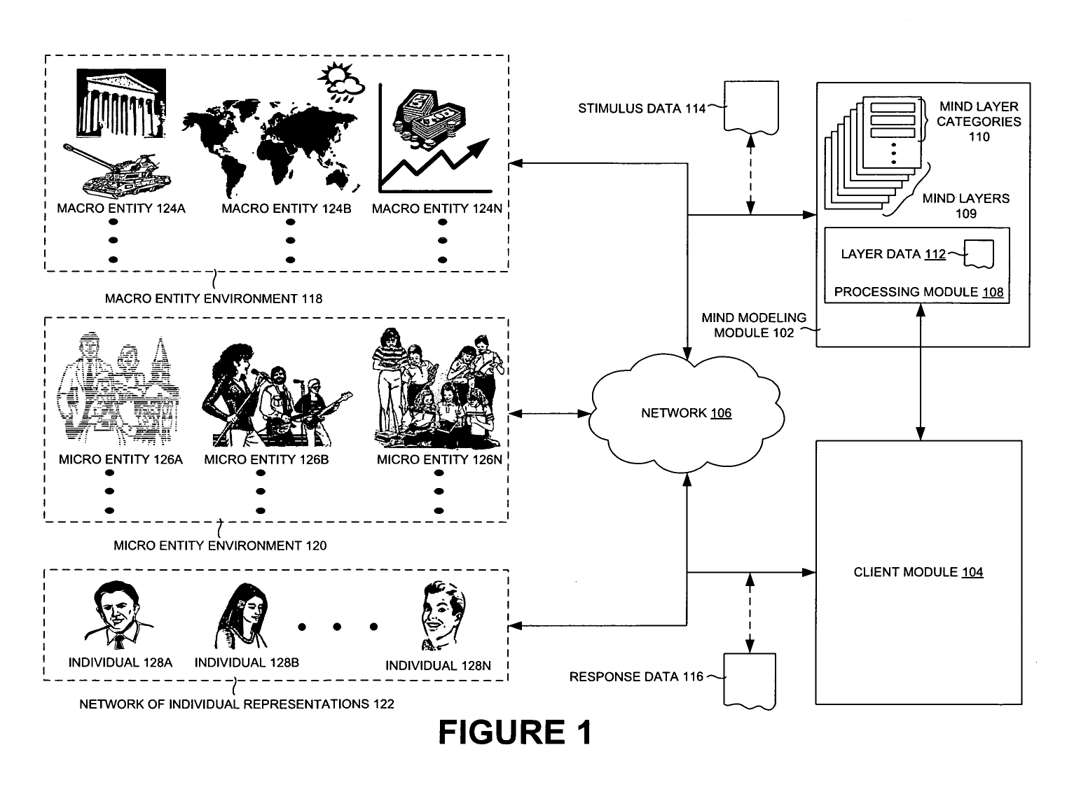

In one embodiment, a method of a personality test includes determining a set of mind layer attributes based on a library of categories, analyzing a set of mind layer categories (e.g., the mind layer categories 110 of FIG. 1) through a variable chosen from a group including a resistance to change variable and an intensity variable, evaluating the mind layer categories 110 through the set of layers (e.g., the mind layers 109 of FIG. 1), and determining a variance of a category distribution of the set of layers 109.

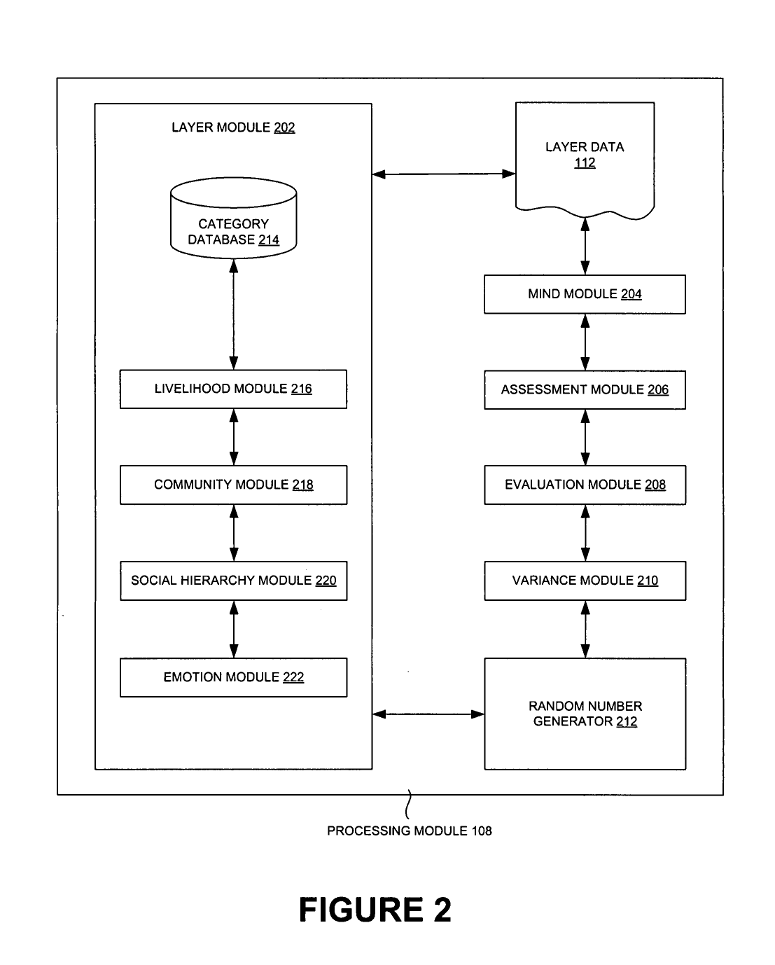

In another embodiment, an apparatus includes a mind module (e.g., the mind module 204 of FIG. 2) to determine a set of mind layer attributes based on a library of categories, an assessment module (e.g., the assessment module 206 of FIG. 2) to determine a set of mind layer categories 110 through a variable chosen from a group comprising a resistance to change variable and an intensity variable, an evaluation module (e.g., the evaluation module 208 of FIG. 2) to evaluate the mind layer categories 110 through the set of layers 109, and a variance module (e.g., the variance module 210 of FIG. 2) to determine a variance of a category distribution of the set of layers 109 through an algorithm that considers a relative probability of any particular event occurring.

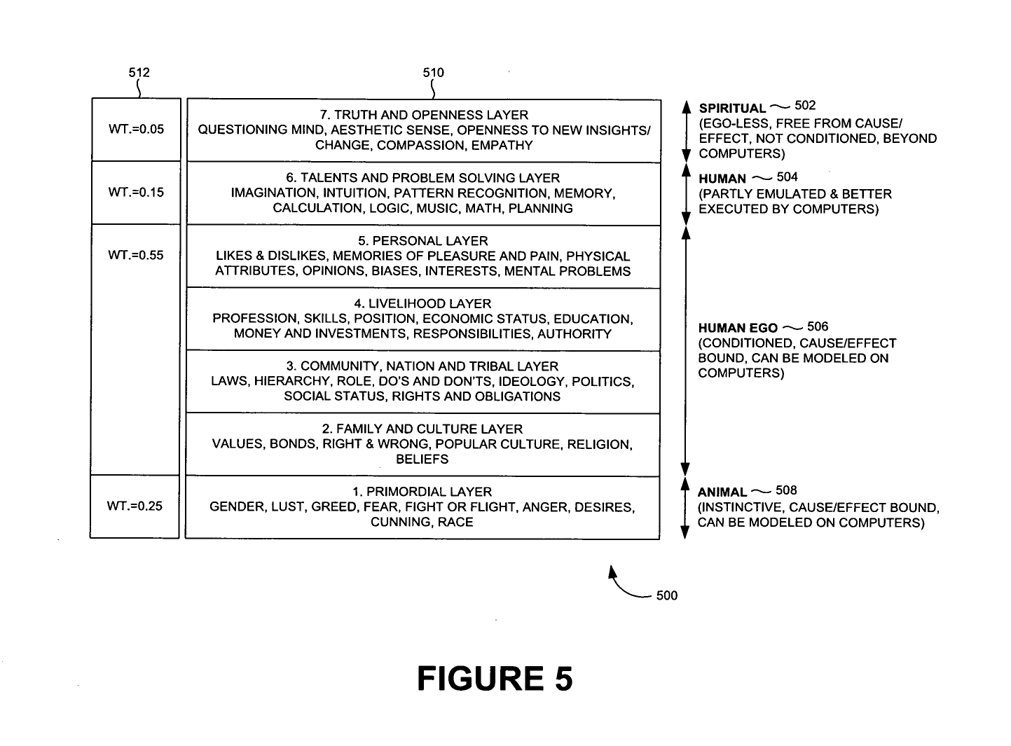

In yet another embodiment, a system includes a mind modeling module (e.g., the mind modeling module 102 of FIG. 1) to generate a simulation of a mind structured in a multi-layer model (e.g., as illustrated in FIG. 5) in which a highest layer (e.g., layer 7) includes a truth attribute having a lack of ego connotation and a power of transformation of various mind layers of an individual, a layer (e.g., layer 6) adjacent to the highest layer (e.g., layer 7) includes talents, skills, a knowledge acquisition and/or expanding an intellectual capacity of a mind through an increase of certain responses and intensities in that layer (e.g., layer 6), a set of other layers (e.g., layers 1-5) to modify the connotations of the mind through a resistance to a change which is incorporated through a threshold value, and to allow the change to occur when the random number exceeds the resistance to change, and a network (e.g., the network 106 of FIG. 1).

The system also includes a client module (e.g., the client module 104 of FIG. 1) to generate a stimulus (e.g., the stimulus data 114 of FIG. 1) through a macro entity (e.g., of the macro entities 124A-N of FIG. 1) pegged to an individual factor and/or a micro entity (e.g., of the micro entities 126A-N of FIG. 1) pegged to a personal experience factor, match the stimulus 114 with a response (e.g., the response data 116 of FIG. 1), and determine a connotation mapping and a connotation response mapping based on the stimulus 114.

FIG. 1 is a system view of a mind modeling module 102 and a client module 104 communicating with various entity environments and/or individuals through a network 106, according to one embodiment. Particularly FIG. 1 illustrates the mind modeling module 102, the client module 104, the network 106, a processing module 108, mind layers 109, mind layer categories 110, layer data 112, stimulus data 114, response data 116, a macro entity environment 118, a micro entity environment 120 and a network of individual representations 122, according to one embodiment.

The mind modeling module 102 may generate a simulation of a mind structured in a multi-layer model (e.g., as illustrated in FIG. 5). In one example embodiment, the multi-layer model includes a highest layer, a layer adjacent to the highest layer, a set of other layers and a lower layer. For example, the multi-layer model may include seven layers namely a primordial layer, a family and culture layer, a community, nation and tribal layer, a livelihood layer, a personal layer, a talents and problem solving layer, and a truth and openness layer, as illustrated in layer framework of FIG. 5. The simulation may correspond to a time period analysis of an effect of the stimulus data 114 having a summary of weighted responses that are any one of a positive response and a negative response.

The client module 104 may generate the stimulus data 114 through the macro entity 124 pegged to an individual factor and the micro entity 126 pegged to a personal experience factor and match the stimulus data 114 in a particular layer with a response. The client module 104 may further determine a connotation mapping and a connotation response mapping based on the stimulus data 114.

The network 106 may facilitate communication (e.g., of the stimulus data 114 and the response data 116) between the mind modeling module 102, the client module 104 and any one of the macro entities 124A-N, the micro entities 126A-N and the individuals 128A-N. The processing module 108 may process attribute data based on a personality test associated with the macro entities 124A-N, the micro entities 126A-N and/or the individuals 128A-N. In one example embodiment, the attribute data may be determined based on a library of categories.

The mind layers 109 may represent a layer framework of the set of mind layers in the multi-layer model. An example embodiment of the layer framework is illustrated in FIG. 5. The mind layer categories 110 may be a set of layer categories associated with the multi-layer model. The mind layer categories 110 may include a primordial layer (e.g., layer 1) having attributes such as gender, lust, greed, fear, anger and/or race, etc., a family and culture layer (e.g., layer 2) having attributes such as importance, bonds, and/or values, etc., a community, nation and tribal (e.g., layer 3) having attributes such as basis, place, political and/or civic, etc., a livelihood layer (e.g., layer 4) having attributes such as occupation and/or financial, etc., a personal layer (e.g., layer 5) having attributes such as likes/dislikes, memories, physical attributes and/or interests, etc., a talents and problem solving layer (e.g., layer 6) having attributes such as innate and/or education and experience, etc. and a truth and openness layer (e.g., layer 7) having attributes such as curiosity, openness to change, aesthetics and/or empathy, etc. In one embodiment, the mind layer categories 110 associated with the multi-layer model may be further categorized into sub-categories to finely characterize each unique mind.

The layer data 112 may include information associated with each layer in the multi-layer model such as a weight assigned to each layer, range of random numbers associated with the weight, an intensity variable and/or a resistance to change variable, etc. The stimulus data 114 may be a set of data inputted to a computer simulation model during a simulation run and which causes an organism to perform an activity or start a reaction.

In one embodiment, the stimulus data 114 is tagged to individual layer categories (e.g., the mind layer categories 110 of FIG. 1) and an origin (e.g., any one of the macro entity 124, the micro entity 126 and the individual 128) of the stimuli based on a set of learnings.

The stimulus data 114 may be divided into three different categories namely macro stimuli (e.g., the stimulus data 114 that come from the macro entity environment 118), micro stimuli (e.g., the stimulus data 114 that come from the micro entity environment 120) and individual stimuli (e.g., the stimulus data 114 that come from the network of individual representations 122).

For example, the macro stimulus data 114 may include national politics, policies of government, weather information, environmental factors, natural disasters, war and peace, economic conditions, etc. The micro stimulus data 114 may include job offer, celebrations, social events, etc. The individual stimulus data 114 may include love, hate, marital issues, relationship with a friend or pet, sight/smell/touch, etc. For example, the stimulus data 114 may include commonly occurring events as well as events that are being specifically investigated in a particular computer simulation study. In one embodiment, the stimulus data 114 may impact a human mind at one or more layers.

The response data 116 may be information associated with change produced in an individual (e.g., of the individuals 128A-N) upon receiving the stimulus data 114. For example, the response data 116 may be any one of pleasure or pain, hostility or amiability, innovation or resignation, fight or flight, consumption, act of honesty or dishonesty, pursuit of sex or money or power, etc. The response data 116 may be generated through an algorithm that considers any one of a probabilistic and a deterministic response to the stimulus.

The macro entity environment 118 may include macro entities 124A-N associated with national politics, policies of governments, weather, environmental factors, natural disasters, war and peace, economic conditions, etc. The micro entity environment 120 may include micro entities 126A-N associated with family, social organization, work place, culture, etc. The network of individual representations 122 may include individuals 128A-N associated with a group and society based on statistical analysis.

In one embodiment, a change in a mind layer 109 of a set of layers (e.g., the layer framework 500 of FIG. 5) may be generated based on an insight gained, a knowledge gained, and a conditioning of an entity represented in the simulation. A response 116 of the entity represented through an iterative process that considers weights, response intensities and connotations may be transformed to future stimuli.

For example, the simulation may be structured in a multi-layer model (e.g., as illustrated in FIG. 5) in which a highest layer (e.g., the truth and openness layer (layer 7) of FIG. 5) includes a truth attribute having a lack of ego connotation and a power of transformation of the various mind layers 109 of the individual 128, a layer adjacent (e.g., the talents and problem solving layer (layer 6) of FIG. 5) to the highest layer includes of talents, skills, a knowledge acquisition and/or expanding an intellectual capacity of a mind through an increase of certain responses and intensities in that layer, a set of other layers (e.g., the layers 1-5 of FIG. 5) to modify the connotations of the mind through a resistance to a change which is incorporated through a threshold value, and allow the change to occur when a random number exceeds the resistance to change.

In one embodiment, a seven layer model (e.g., as illustrated in FIG. 5) may be generated through questioning mind, aesthetic sense, openness to new insights, change, compassion, and empathy in one layer (e.g., the truth and openness layer (layer 7) of FIG. 5), determining imagination, intuition, pattern recognition, memory, calculation, logic, music, math, and planning in another layer (e.g., the talents and problem solving layer (layer 6) of FIG. 5), analyzing likes and dislikes, memories of pleasure and pain, physical attributes, opinions, biases, interests, and mental problems in yet another layer (e.g., the personal layer (layer 5) of FIG. 5), determining livelihood of profession, skills, position, economic status, education, money and investments, responsibilities, and authority in a further layer (e.g., the livelihood layer (layer 4) of FIG. 5), generating a community layer having a set of laws, hierarchy, role, do's and don'ts, ideology, politics, social status, rights and obligations in yet a further layer (e.g., the community, nation and tribal layer (layer 3) of FIG. 5), evaluating family and cultural bonds through an analysis of right and wrong, popular culture, religion, and beliefs in a next layer (e.g., the family and culture layer (layer 2) of FIG. 5), and determining gender, lust, greed, fear, fight or flight, anger, desires, cunning, and race in yet a next layer (e.g., the primordial layer (layer 1) of FIG. 5).

In one embodiment, a series of responses and corresponding weighted scores of an individual mind, a group of minds, and a geographic region may be generated in a report. A set of patterns of experiences (e.g., may include a love variable, an anger variable, a revenge variable, an insight variable, and/or a compassion variable, etc.) that the individual mind, the group of minds, and/or the geographic region is having may be determined. A preference of a particular item may be determined through the set of patterns of experiences shared with at least one other entity. A trace of all changes of the individual mind due to insights, learnings and/or conditionings may be reported.

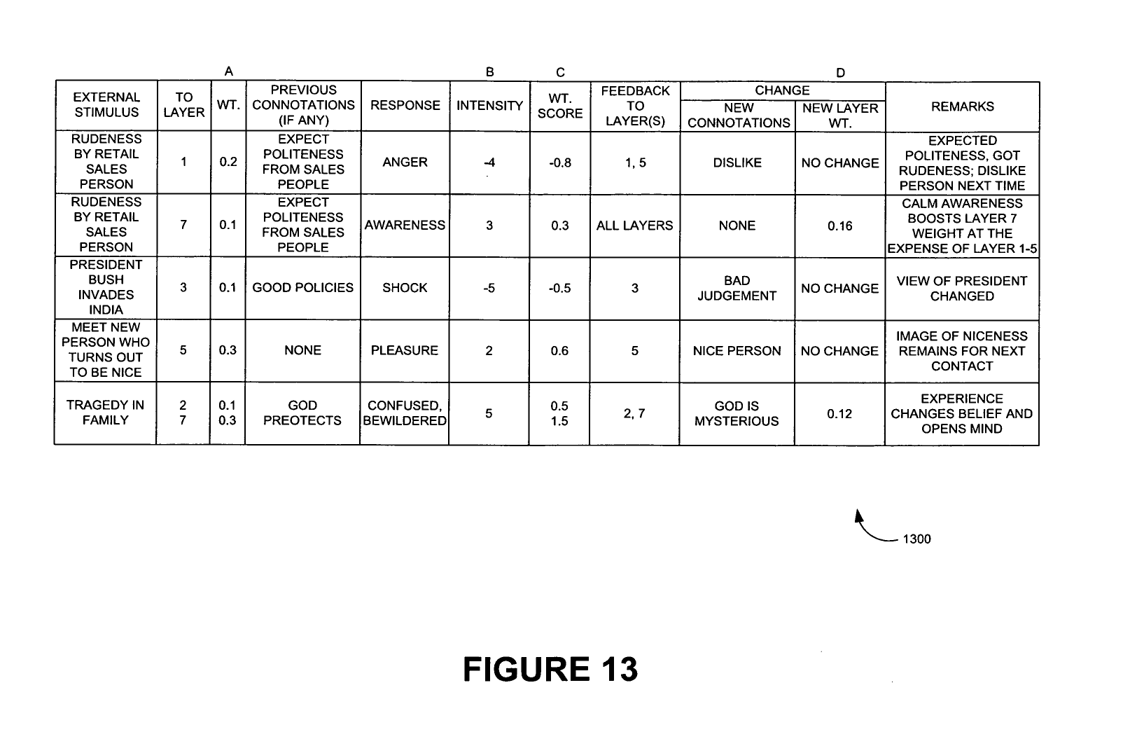

In another embodiment, the network of individual representations 122 may form a group and society having one including a sample size based on statistical analysis to obtain a desired confidence level. The confidence level may be relied through the network of individual representations 122. The network of individual representations 122 may be placed in a collective entity serving as a vessel of recording an aggregate effect of a set of responses 116 of individual minds 128A-N (e.g., as illustrated in FIG. 13). A set of assumptions may be calibrated until a set of results of a simulation are validated through a reality-checking analysis.

The mind modeling module 102 may generate a simulation of a mind structured in a multi-layer model (e.g., as illustrated in FIG. 5) in which a highest layer (e.g., the truth and openness layer (layer 7) of FIG. 5) includes a truth attribute having a lack of ego connotation and a power of transformation of various mind layers 109 of an individual 128, a layer adjacent (e.g., the talents and problem solving layer (layer 6) of FIG. 5) to the highest layer consists of talents, skills, a knowledge acquisition and expanding an intellectual capacity of a mind through an increase of certain responses and intensities in that layer, a set of other layers (e.g., the layers 1-5 of FIG. 5) modify the connotations of the mind through a resistance to a change which is incorporated through a threshold value, and to allow the change to occur when the random number exceeds the resistance to change.

FIG. 2 is an exploded view of the processing module 108 of FIG. 1, according to one embodiment. Particularly, FIG. 2 illustrates a layer module 202, a mind module 204, an assessment module 206, an evaluation module 208, a variance module 210, a random number generator 212, a category database 214, a livelihood module 216, a community module 218, a social hierarchy module 220 and an emotion module 222, according to one embodiment.

The layer module 202 may generate seven layer model through determining, analyzing and/or evaluating different attributes associated with respective layers (illustrated in FIG. 5). In the example embodiment illustrated in FIG. 2, the layer module 202 includes a category database 214, a livelihood module 216, the community module 218, the social hierarchy module 220 and the emotion module 222. The mind module 204 may determine a set of mind layer attributes based on a library of categories 110. The assessment module 206 may determine a set of mind layer categories 110 through a variable. In one embodiment, the variable may be selected from a group including a resistance to change variable and an intensity variable.

The evaluation module 208 may evaluate the mind layer categories 110 through a set of layers (e.g., the set of mind layers 109 illustrated in FIG. 1). The variance module 210 may determine a variance of a category distribution of the set of layers through an algorithm that considers a relative probability of any particular event occurring. The random number generator 212 may map stimuli to a particular layer and an origin of the stimuli. In one embodiment, the random number generator 212 generates a random number (e.g., having values ranging from 0.01 to 0.99). If the random number generator 212 determines a value less than a threshold value, then data are routed to the truth and openness layer (layer 7).

The categories database 214 may include information associated with different categories of the multi-layer model layers. The categories in the categories database 214 may be different from one another and associated with the different layers in the multi-layer model. The livelihood module 216 may determine profession, skills, position, economic status, education, money or investments, responsibilities, and authority in the livelihood layer (layer 4).

The community module 218 may generate a community layer having a set of laws, hierarchy, role, do's and don'ts, ideology, politics, social status, rights and obligations in the community, nation and tribal layer (layer 3). The social hierarchy module 220 may value family and cultural bonds through an analysis of right and wrong, popular culture, religion, and beliefs in the family and culture layer (layer 2). The emotion module 222 may determine gender, lust, greed, fear, fight or flight, anger, desires, cunning, and race in the primordial layer (layer 1).

A set of mind layer attributes may be determined based on a library of categories (e.g., the category database 214 of FIG. 2). A set of mind layer categories (e.g., the mind layer categories 110 of FIG. 1) may be analyzed through a variable chosen from a group including a resistance to change variable and an intensity variable. The mind layer categories 110 may be evaluated through the set of layers 109.

A variance of a category distribution of the set of layers 109 may be determined. The stimulus (e.g., the stimulus data 114 of FIG. 1) may be mapped to the layer 109 and the origin through the random number generator 212. Data may be routed to a truth and openness layer data (layer 7) of the processing module 108 when the random number generator 212 determines a value lower than a threshold value.

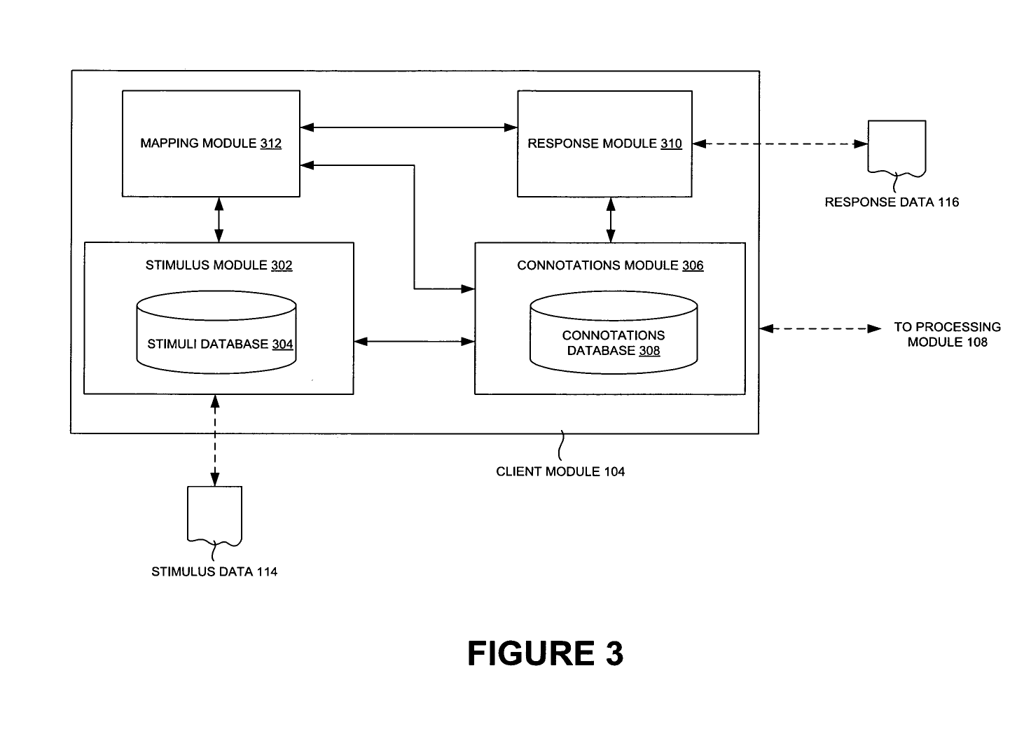

FIG. 3 is an exploded view of the client module 104 of FIG. 1, according to one embodiment. Particularly, FIG. 3 illustrates a stimulus module 302, a stimuli database 304, a connotations module 306, a connotations database 308, a response module 310 and a mapping module 312, according to one embodiment.

The stimulus module 302 may generate a stimulus data 114 to be inputted to a computer simulation model during a simulation run. For example, the stimulus data 114 may include commonly occurring events as well as events that are being specifically investigated in a particular computer simulation study. The stimuli database 304 may contain stimulus data 114 including commonly occurring events as well as events that are being specifically investigated in a particular computer simulation study.

In one embodiment, the stimulus data 114 in the stimuli database 304 is tagged to individual mind layer categories and an origin of stimuli based on the set of learnings. For example, the stimulus data 114 stored in the stimuli database 304 may be associated with good or bad news, pleasant or unpleasant input, reward or punishment, entertainment and thrills, love, respect, courtesy, hate, disrespect, rudeness, food, clothing and shelter, whether, war, conflict or peace, economic prosperity, depression, nature and the environment, family and friends, goods and services, threat (physical, emotional, financial), etc.

The connotations module 306 may generate a library of connotations which evolves based on a set of learnings, insights and thoughts. The connotations database 308 may include broadly-shared, narrowly-shared, and individual-specific connotations. The connotations database 308 may enable emulations/simulations of human mind. In one example embodiment, the human mind interacts with the connotations database 308, uses it for interpreting external stimuli or conversely, changes the connotations database 308 based on set of learnings, insight and/or thought, etc.

The response module 310 may generate a response to the stimulus data 114 having an intensity and resistance through any one of a macro entity pegged to an individual factor and a micro entity pegged to a personal experience factor. In one embodiment, the response module 310 may generate a response through an algorithm that considers any one of a probabilistic and a deterministic response to the stimulus. The response to stimulus factors may include an insight, a learned training, an innate trait, an instinct, a talent and/or a skill, etc. The mapping module 312 may match the stimulus (e.g., the stimulus data 114 of FIG. 1) with the response. The mapping module 312 may also determine a connotation mapping and connotation response mapping based on the stimulus 114.

A library of connotations (e.g., the connotations database 308 of FIG. 3) which evolves based on a set of learnings, insights and/or thoughts may be generated. A library of stimuli (e.g., the stimulus database 304 of FIG. 3) tagged to individual layer categories (e.g., the layer categories illustrated in FIG. 5) and an origin of stimuli may be developed based on the set of learnings. A response (e.g., the response data 116 of FIG. 1) to stimulus factors may include an insight, a learned training, an innate trait, an instinct, a talent, and/or a skill, etc.

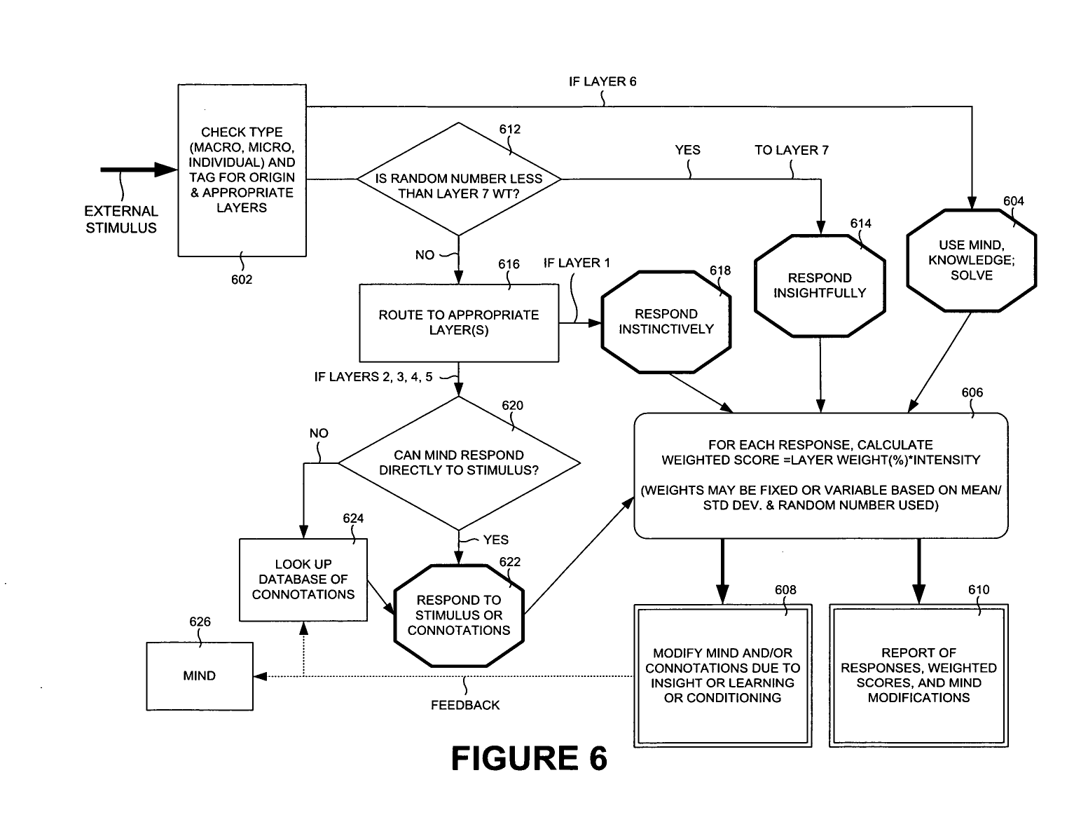

The response 116 to a stimulus (e.g., the stimulus data 114 of FIG. 1) having an intensity and resistance may be generated through a macro entity 124 pegged to an individual factor and/or a micro entity 126 pegged to a personal experience factor. In addition, the response may be generated through an algorithm (e.g., of FIG. 6) that considers a probabilistic and/or a deterministic response to the stimulus 114.

The stimulus 114 may be enhanced through an addition of a factor determined by a user input. In one embodiment, the stimulus 114 may be matched with the response 116 and a connotation mapping and a connotation response mapping may be determined based on the stimulus 114. For example, a response 116 may be generated back to an individual 128 responsive to the connotation response mapping of the individual 128.

A response 116 may be generated back to a micro entity 126 responsive to the connotation response mapping of the micro entity 126 including a family, a community and an association. A response 116 may be generated back to a macro entity 124 responsive to the connotation response mapping of the macro entity 124 including a geographic group, a social group and a civic body. An exception variable may be provided of a stimulus 114 from one entity response in a response to the individual 128, the micro entity 126 and/or the macro entity 124.

The client module 104 may generate a stimulus (e.g., the stimulus data 114 of FIG. 1) through the macro entity 124 pegged to an individual factor and/or the micro entity 126 pegged to a personal experience factor, match the stimulus 114 with a response (e.g., the response data 116 of FIG. 1), and determine a connotation mapping and a connotation response mapping based on the stimulus 114.

An instruction set may determine a set of patterns of experiences (e.g., an individual mind, a group of minds, a geographic group, a social group, a civic body, a nation, and/or a global collective, etc.) of an entity (e.g., the macro entity 124, the micro entity 126 and the individual 128 of FIG. 1) represented through an iterative process that considers weights, response intensities and connotations to future stimuli.

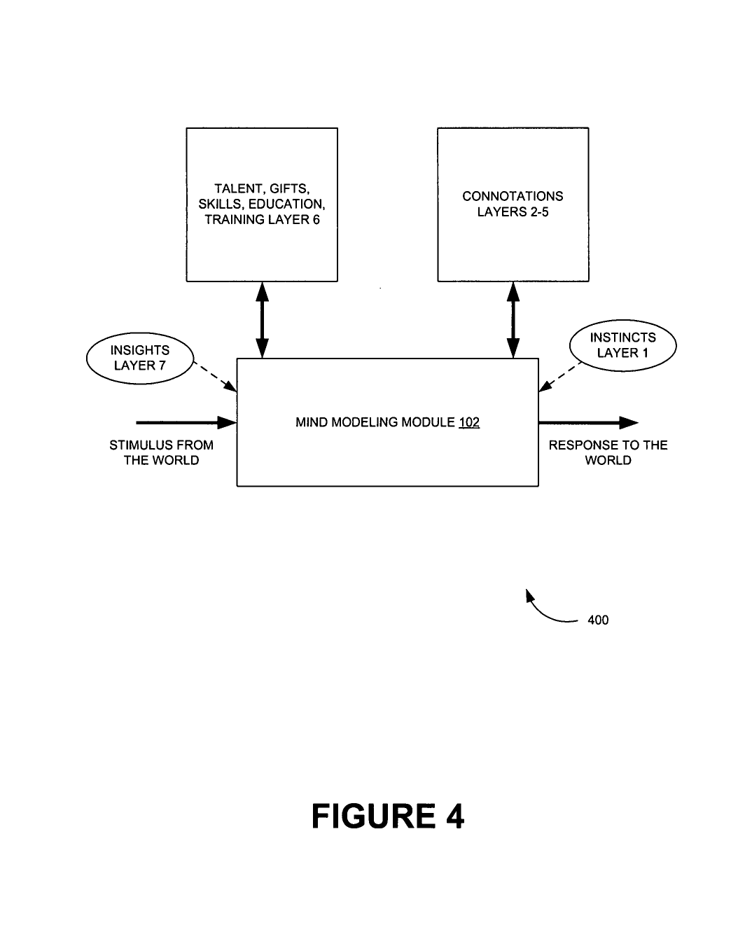

FIG. 4 is a system view of the mind modeling module 102 of FIG. 1, according to one embodiment. As illustrated in FIG. 4, each mind may subject to external stimuli 114 from the macro entities 124A-N, the micro entities 126A-N and the individuals 128A-N. The stimuli 114 may be good or bad news, pleasant or unpleasant input, reward or punishment, entertainment and thrills, love, respect, courtesy, hate, disrespect, rudeness, food, clothing and shelter, the whether, war, conflict or peace, economic prosperity, depression, nature and the environment, family and friends, goods and services, threat (physical, emotional, financial), etc. Each mind may receive these stimuli 114, process them at some layer, use connotations, and then respond to the stimuli 114.

The response 116 can be any one of pleased or displeased, happy, sad and indifferent, show love, respect, courtesy, project hatred, disrespect, anger, help or hurt or be indifferent to others, produce value to society, be a burden on society, innovate, lead, follow or obstruct or be gullible, act honestly or dishonestly, consume, generate waste, recycle, aid the environment, pursue sex, money or power, fight (solve), flight (run), etc.

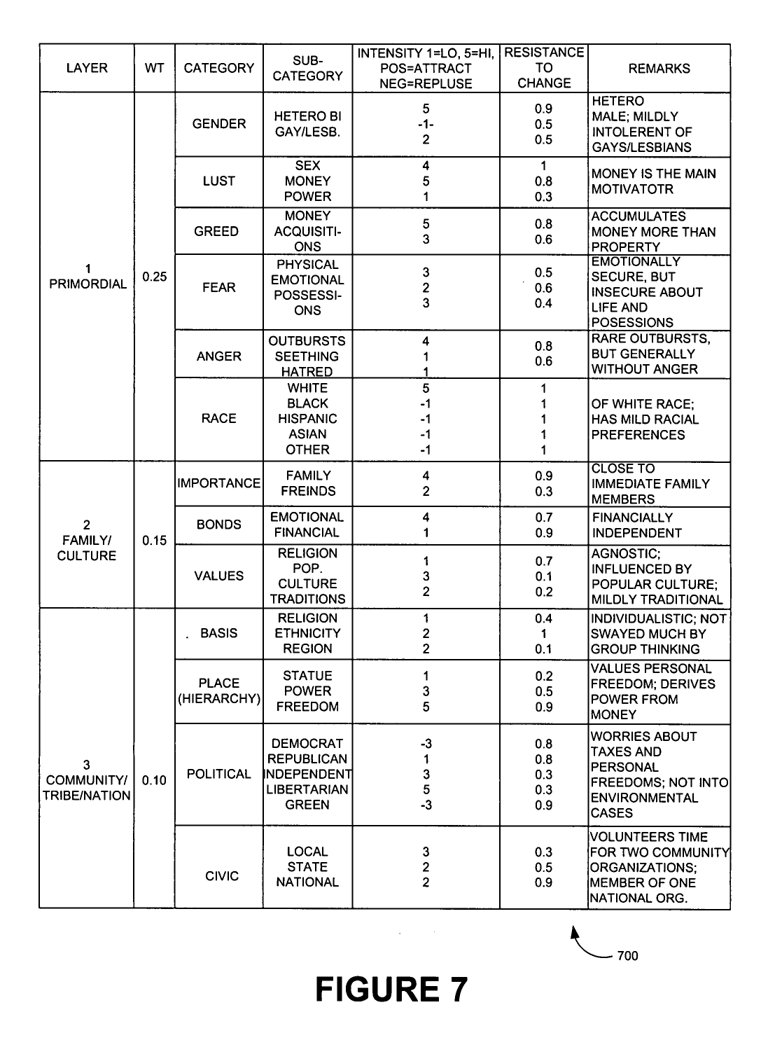

In processing the responses 116 to the stimuli 114, the mind may act out its own personality (as illustrated in FIGS. 7, 8, 9, 10). Further, ego may come into play in and the mind may respond to pleasing sensations (flattery, rewards, love) favorably and to unpleasant sensations unfavorably. Also, the ego causes the mind to remember insults for possible future vengeful acts, and to pursue gain (sex, money, power, possessions) in a self centered way.

Such ego-centric acts may emanate out of every layer except the truth and openness layer (layer 7) and the talents and problem solving layer (layer 6). The truth and openness layer (layer 7) may be considered as layer of non-response as the response 116 to the external stimuli 114 is not mechanical, not conditioned by primordial traits or past experiences or connotations. In the truth and openness layer (layer 7), the mind may quietly observe, learn and gain insight from all kinds of stimuli, see a larger picture, and project understanding and compassion.

The layer 7 may have the power to change the personality of the other layers. In addition, human potential for spiritual growth may be derived from the truth and openness layer (layer 7). The insights into truth gained at the truth and openness layer (layer 7) may change the weights and intensity scores of the layers 1-6.

The talents and problem solving layer (layer 6) may not subject to connotations as it is to innate talent, experience, skill, education, and training. Further, the talents and problem solving layer (layer 6) may not be characterized by mechanical response to the extent that imagination, intuition, and innate gifts are involved (all non-mechanical in nature). The primordial layer (layer 5) may be characterized by instinctive response, while the human ego layers (layers 2-5) can involve connotations; i.e., a stimulus may be responded to either directly or after connotations have been understood.

FIG. 5 is a layer framework 500 of the multi-layer model of a human mind, according to one embodiment. Particularly, FIG. 5 illustrates a spiritual level 502, a human level 504, a human ego level 506, an animal level 508, layers 510 and layer weights 512, according to one embodiment.

The multi-layer model of a mind may be composed of seven layers 510 (e.g., the set of mind layers 109 of FIG. 1). Different minds may emphasize different layers, as illustrated by the layer weights 512. The spiritual level 502 may include the truth and openness layer (layer 7), where the mind may be ego-less, free from cause/effect, not conditioned and/or beyond computers. The human level 504 may include talents and problem solving layer (layer 6), where the person or mind may be partly emulated and better executed by computers.

The human ego level 506 may include the personal layer (layer 5), the livelihood layer (layer 4), the community, nation and tribal layer (layer 3), and the family and culture layer (layer 2), where the mind may be conditioned, cause/effect bound and modeled on computers. The animal level 508 may include the primordial layer (layer 1), where the person or mind may be instinctive, cause/effect bound and can be modeled on computers.

In addition, the seven layers 510 may be generated through the layer or attribute framework 500. For example, the layer or attribute framework 500 may include determining the truth and openness layer (layer 7) which includes questioning mind, aesthetic sense, openness to new insights, change, compassion, and empathy, determining the talents and problem solving layer (layer 6) which includes imagination, intuition, pattern recognition, memory, calculation, logic, music, math, and planning, and analyzing the personal layer (layer 5) having likes and dislikes, memories of pleasure and pain, physical attributes, opinions, biases, interests, and mental problems.

The layer or attribute framework 500 may also include determining the livelihood layer (layer 4) having profession, skills, position, economic status, education, money or investments, responsibilities, and authority, generating a community, nation and tribal layer (layer 3) having a set of laws, hierarchy, role, do's and don'ts, ideology, politics, social status, rights and obligations, evaluating family and cultural layer (layer 2) through an analysis of values, bonds, right and wrong, popular culture, religion, and beliefs, and determining the primordial layer (layer 1) having gender, lust, greed, fear, fight or flight, anger, desires, cunning, and race.

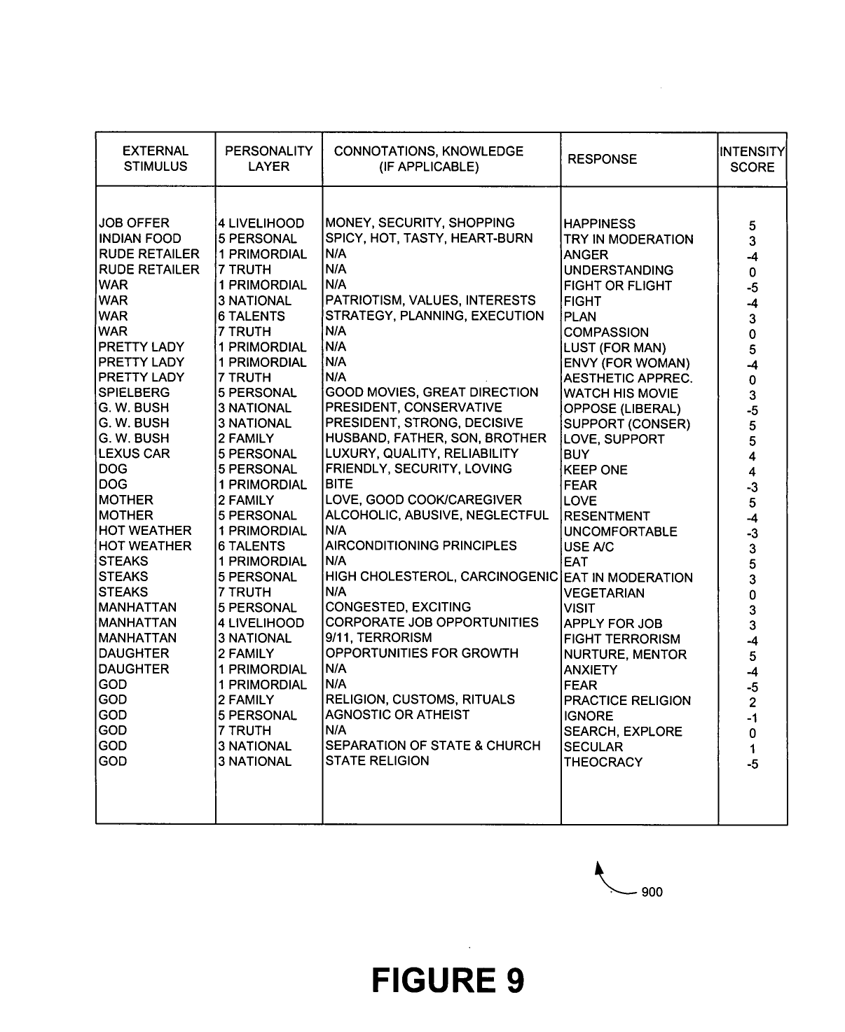

Further, the seven layer model may assign a different weight (e.g., the layer weights 512 as illustrated) to each level (e.g., the spiritual level 502, the human level 504, the human ego level 506 and the animal level 508) with a total of all the weights 512 adding up to 1, showing relative composition of each person or mind. For example, the weights are apportioned to ensure a soul-searching understanding of each mind and the relative proportions of various elements of its personality. In one example embodiment, a weighted score may be generated using a product of a layer weight and intensity through a computer simulation (e.g., as illustrated in FIG. 9). Different minds will have to be assigned different weights 512 corresponding to each layer.

For example, people living in America (e.g., an individualistic society) can be expected to have a higher weight for the personal layer (layer 5) whereas someone living in Iraq or Saudi Arabia or Japan who might be assigned a higher weight for the community, nation and tribal layer (layer 3). In another example, a particularly vain person, with a lot of emphasis on his/her physical attributes (looks, etc.), with strong likes and dislikes, will also have a higher weight attached to the personal layer (layer 5) than someone who is self-effacing and easy-going.

In yet another example, Socrates, Plato, and/or eastern mystic will be heavily weighted in the top-most truth and openness layer (layer 7), while Isaac Newton would be weighted heavily in both the top-most (layer 7) layer and in the talents and problem solving layer (layer 6). Conversely, a hardened criminal under the grip of base impulses would be weighted more heavily in the primordial layer (layer 1).

In the example embodiment illustrated in FIG. 5, the weights 512 assigned to each layer must add up to 1. The layer weights 512 shown are for a hypothetical human mind and will vary from mind to mind. As per the example illustrated in FIG. 5, the mind (individual) belongs to 5% spiritual level 502, 15% human level 504, 55% human ego level 506, and 25% animal level 508. The human ego level 506 may have separate weights 512 for the 4 layers in it.

FIG. 6 is a flow diagram of a mind modeling algorithm of the processing module of FIG. 1, according to one embodiment. In step 602, the external stimulus 114 is first recognized for entity type (e.g., the macro entity 124, the micro entity 126 and/or individual 128), a specific origin, and one or more layers 510 that the stimulus 114 needs to be routed to. If layer 6 (Talents and problem solving layer) is indicated, then the stimulus 114 is routed to step 604, where a response 116 uses mind knowledge and solves the problem.

Otherwise, a random number (between 0.01 and 0.99) is generated (e.g., through the random number generator 212 of FIG. 2) and checked to see if it is less than the weight for layer 7 (e.g., truth and openness layer) in step 612. If the random number is less than the weight for layer 7, then the stimulus 114 is routed to step 614, where the mind responds insightfully. In one embodiment, the processing algorithm reflects the notion that insight is a chance occurrence. The greater the weight of layer 7 in a particular mind, the greater the probability that the mind will be insightful and see truth.

If the random number is greater than the layer 7 weight, the stimulus 114 is routed to step 616 where the other appropriate layers (e.g., the human ego level 506 and the animal level 508) are checked. In step 616, if the stimulus 114 is matched with layer 1 (e.g., the primordial layer 1), then the process is routed to animal level 508, where the mind responds instinctively. Further, in step 616, if the stimulus 114 is matched with layers 2, 3, 4 and/or 5, then the stimulus 114 is routed to step 620.

In step 620, a condition is checked whether the mind responds directly to the stimulus 114 or not. If the mind does not respond directly to the stimulus 114, then model may look up for the database of connotations 308 to yield responses 116 in step 624. For example, the person's database of connotations 308 may include broadly-shared, narrowly-shared, and/or individual-specific connotations. Further, the process is routed to step 622 from the step 624.

In operation 620, if the mind responds directly to the stimulus 114, then the process may be routed to step 622 where the mind may respond for the stimulus 114 or connotations. In one example embodiment, the stimulus 114 is matched in one or more of the layers (e.g., the layers 1-7) either directly with the responses 116 or first with the database of connotations 308 to yield the response(s) 116. Further, the process may be routed from step 604, step 614, step 618 and/or step 622 to step 606.

In operation 606, the weighted scores for each response 116 (e.g., as illustrated in step 604, 616, 618 and/or 622) may be calculated. Since each response 116 has an intensity score and a layer weight associated with it, a score using the product of the layer weight (%) and intensity can be generated. In step 608, the mind and/or connotations are modified due to insight, learning or conditioning. In step 610, a report associated with responses 116, weighted scores and/or mind modifications may be generated. In step 626, a feedback for the mind modification/transformation may be generated and sent back to mind.

In some embodiments, the following process must happen for the algorithm to work since computers are machines and cannot infer anything on their own. (a) one-to-one/many mapping/correspondence between stimulus and response(s), (b) one-to-one/many mapping/correspondence between stimulus and connotation(s) followed by one-to-one/many mapping between connotation and response(s).

Therefore, databases of stimuli 304, connotations 308 and responses must be created first with such one-to-one/many mapping. After that, the computer simply does the matching by looking up the databases.

Regarding the direction of the response 116, the following may be used.
1. A stimulus 114 from an individual will result in a response 116 back to that individual.
2. A stimulus 114 from a micro entity 126 (family, community, association) will result in a response back to that micro entity 126.
3. A stimulus from the macro entity 124 (nation, world) would result in a response back to the macro entity 124.

Exceptions to these rules (e.g., a stimulus from one entity results in a response to another entity) would have to be specified separately.

In one example embodiment, when a mind experiences and/or processes a stimulus, it undergoes change due to insight gained, knowledge gained, and/or conditioning. Insight can be transformative and can make a mind less animal, less ego-centric and/or more open to truth. In addition, a mind conditioning refers to modifying the cause-effect behavior, such as through reward or punishment, praise or criticism, pleasant or unpleasant contact, etc.

In the processing algorithm illustrated in FIG. 6, a feedback works by using the weighted score generated for a stimulus to go back and alter the mind (In step 626) by changing the weights, response intensities or connotations to be used for future stimuli. In one embodiment, the variance may be generated through an algorithm (e.g., as illustrated in FIG. 6) that considers any of a random selection and a relative probability of a particular event occurring.

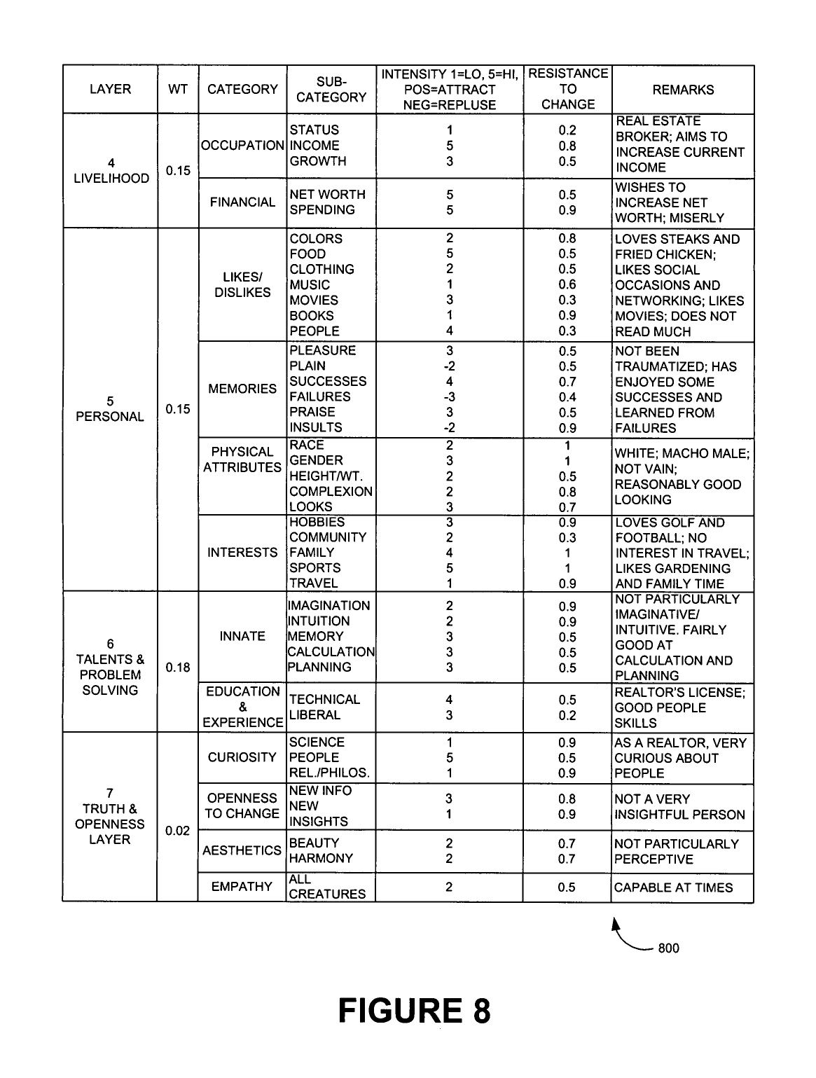

FIG. 7 and FIG. 8 are table views 700 and 800 respectively, of the layer framework 500 of FIG. 5 illustrating intensity and resistance to change variables of mind layer categories and subcategories, according to one embodiment.

Particularly, FIG. 7 illustrates attributes of the primordial layer 1, the family and culture layer 2 and the community, nation and tribal layer 3.

FIG. 8 is a continuation of the table view of FIG. 7 further illustrating attributes of the livelihood layer 4, the personal layer 5, the talents and problem solving layer 6 and the truth and openness layer 7, according to one embodiment.

In one example embodiment, a representation of the individual mind would vary from mind to mind by weights attached to each category or sub-category. The score (e.g., on a scale of 1 to 5) shown for each sub-category may be a measure of response intensity and used in emulations/simulations. In one example embodiment, a positive value shows attraction and a negative value shows repulsion or aversion.

The resistance to change may be an indicator of how inflexible and/or resistant a person is to change (e.g., ‘0’ is completely open to change, ‘1’ is totally opposed to change). The resistance to change may vary with each person by layer, category, sub-category and/or sub-sub-category, etc. For example, an individual may be open to changing their travel preferences, but totally opposed to changing their religious preferences. In another example, some people are more open to new things than others.

The representation of the human mind may be a framework and/or an approach. The detailed representation of the human mind can be refined as illustrated in the following example embodiments.

In one example embodiment, further breakdown (another column) may be added within each sub-category to more finely characterize each unique mind. For example, if a sub-sub-category were shown, food preferences in the personal layer (layer 5) can be broken down into Chinese, Continental, Japanese, Italian, Indian, vegetarian, etc. Similarly, color preferences can be broken into the various rainbow colors and/or individual preferences. In the livelihood layer (layer 4), more detail can be shown regarding the particular profession (law, engineering, medicine, clerical, blue-collar, farm worker, etc.), and status can be shown as upper, lower management, or individual contributor, etc.

In another example embodiment, the details of the representation of the human mind can be refined by introducing the idea of connotations. Some items in the sub-category or sub-sub-category come with heavy baggage. For example, a profession such as ‘Used car salesman’ means something to people (rightly or wrongly). Similarly, a nationality such as American has many connotations (e.g., super-power, advanced, arrogant, etc.). A Harvard education has its connotations, as does being of the brown or any other race.

In yet another example embodiment, the details of the representation of the human mind characterized by layers, categories, sub-categories, sub-sub-categories, etc., can be refined and adjusted based on research by psychologists, sociologists and/or others, using elaborate studies and/or surveys of many people. Further, personality tests may be given to individuals 128A-N to determine each person's proportions vis-à-vis the 7 layers, as well as the individual's response (and intensity) to different kinds of stimuli or their connotations.

In further example embodiment, the details of the representation of the human mind can be refined through assigning the weights. i.e., the weight can be viewed as the mean for a particular layer with a standard deviation around it. For example, a very consistent person with predictable behavior will have a lower standard deviation than an inconsistent person given to wild swings in behavior patterns. In another example, in a computer simulation, the random number generator 212 could be used to produce varying weights based on the mean and standard deviation.

FIG. 9 is a table view 900 of mind layers 109, connotations and responses corresponding to external stimuli, according to one embodiment. Particularly, FIG. 9 illustrates the external stimuli, personality layers (e.g., where the stimuli are impacted), connotations associated with the stimuli and corresponding responses and intensity score, according to one embodiment.

The external stimuli (e.g., the stimulus data 114 of FIG. 1) may include macro stimuli, micro stimuli, individual stimuli, etc. Each mind may subject to the stimuli 114 from the world, from family and friends, from other individuals, groups, the environment or the world at large. These stimuli 114 may be pleasant or unpleasant, threatening or reassuring, rewarding or punishing, characterized by love or hatred or indifference, etc. In one embodiment, each mind receives these stimuli 114, processes them at some level (layer), uses connotations where applicable, and then responds to the stimuli 114. In another embodiment, the stimulus data 114 may impact a human mind at one or more layers (e.g., layers 1-7). For example, the external stimulus ‘war’ may have an impact on the different mind layers such as primordial layer (layer 1), national layer (layer 3), talents layer (layer 6), truth layer (layer 7) which are processed differently based on the different connotations, varying responses are generated as illustrated in FIG. 9.

In one embodiment, connotations may refer to baggage of associations that comes with many things. For example, if the stimulus is ‘America being involved in some part of the world’, then the word America may have a set of associations depending on one's frame of mind. The word may connote power, riches, technological advancement, goodness, generosity, arrogance, hubris, imperialism, etc. Likewise, the word ‘alcohol’ has connotations. Some may view it as welcome relief or fun in a stressful world, others as a waste of money and corrupting influence on people's minds. In one or more embodiments, the mind responds not to the stimulus itself but to the connotations.

In processing responses (e.g., the response data 116 of FIG. 1) to the external stimuli 114, the mind may act out its own personality based on the connotations. Further, the ego (e.g., the center of the mind) comes into play and the mind may respond to pleasing sensations (e.g., flattery, rewards, love, etc.) favorably and to unpleasant sensations unfavorably. The ego may also cause the mind to remember insults for possible future vengeful acts, and to pursue gain (sex, money, power, possessions) in a self-centered way.

Self-centered (or ego-centric) acts may emanate out of every mind layer except the truth and openness layer (layer 7) and the talents and problem solving layer (layer 6). For example, the top layer 7 may be the one where response to external stimuli is not mechanical, not conditioned by primordial traits or past experiences or connotations and may be considered as the layer of non-response. In one embodiment, layer 7 may be where the mind quietly observes, learns and gains insights from all kinds of external stimuli, sees the larger picture, and projects understanding and compassion.

In another embodiment, the layer 7 may have a lack of ego connotation and a power to transform the personality at the other mind layers. Further, the implication is that the insights into truth gained at this level (layer 7) may change the weights and intensity scores of the other layers (1-6). For example, the human potential for spiritual growth may be derived from this mind layer. Without it, human beings would be hopelessly conditioned or programmed beings, incapable of responding in any way other than from past experiences, knowledge and primordial tendencies.

The talents and problem solving layer (layer 6) may not be subjected to connotations as it is to innate talent, experience, skill, education and training. The layer 6 may not be characterized by mechanical response to the extent that imagination, intuition and innate gifts are involved (all non-mechanical in nature). The primordial layer (layer 1) may be characterized by instinctive response, while the human ego layers (2 through 5) may involve connotations (e.g., a stimulus 114 may be responded to either directly or after the connotations have been understood). The intensity score given to each response may vary from mind to mind as illustrated in the example embodiment of FIG. 9 and may be used to calculate weighted score and responses 116 in a computer simulation of the human mind.

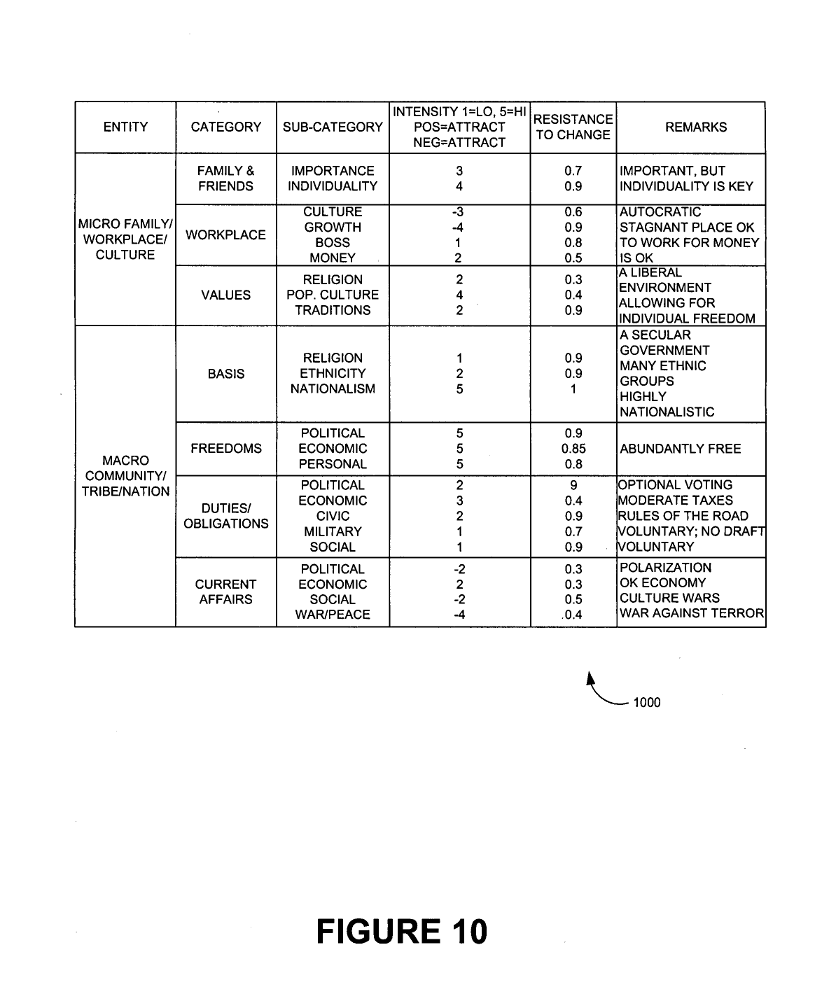

FIG. 10 is a chart view 1000 illustrating categories, sub-categories, an intensity variable and a resistance to change variable associated with the macro entity 124 and the micro entity 126, according to one embodiment. Particularly, FIG. 10 illustrates the entities, categories, sub-categories, intensity, resistance to change and remarks, according to one embodiment.

The stimuli from the world may be categorized as micro stimuli, macro stimuli and individual stimuli. The macro stimuli may be the stimuli that come from the world. For example, macro stimuli may include national politics, the policies of governments, the weather, environmental factors, natural disasters, war and peace, economic conditions, etc. The macro stimuli may affect a large number of individuals 128A-N, each of who may respond similarly or differently depending on the stimulus 114 and the individual 128. In one embodiment, every stimulus 114 from the macro entity environment 118 is tagged to identify the specific macro entity 124 it came from.

The micro stimuli may come from environments that are smaller and closer to the individual 128, such as from the family, a workplace, the community, a club and association, etc. In another embodiment, every stimulus 114 from the micro entity environment 120 is tagged to identify the specific micro entity 126 it came from.

The individual stimuli may come from another individual/entity to the individual 128 (one-on-one). The individual stimuli may include love and hate, marital issues, relationship with a friend or a pet, a sight or smell or touch, etc. In yet another embodiment, every stimulus 114 from an individual is tagged to identify the specific individual it came from.

In the example embodiment illustrated in FIG. 10, categories of the micro entity 126 include friends and family, workplace and values. Further, sub-categories may be included to provide finer detail. For example, the sub-categories of the micro entity 126 include importance, individuality, culture, growth, boss, money, etc. The macro entity 124 includes categories such as basis, freedom, duties and obligations, current affairs, etc. In addition, the sub-categories of the macro entity 124 include religion, ethnicity, nationalism, political, economic, personal, civic, military, social, etc.

The intensity score given to each sub-category may refer to the macro or micro entity's attempt to enforce its collective will on the individual. For example, score 1 refers to low intensity, score 5 refers to high intensity, negative score refers to repulsion, positive score refers to attraction, etc. The resistance to change may refer to inflexibility measure to the stimuli. For example, value 0 means fully open to change to the stimuli (e.g., the macro stimuli, the micro stimuli and the individual stimuli) and 1 means totally opposed to change to the stimuli (e.g., the macro stimuli, the micro stimuli and the individual stimuli).

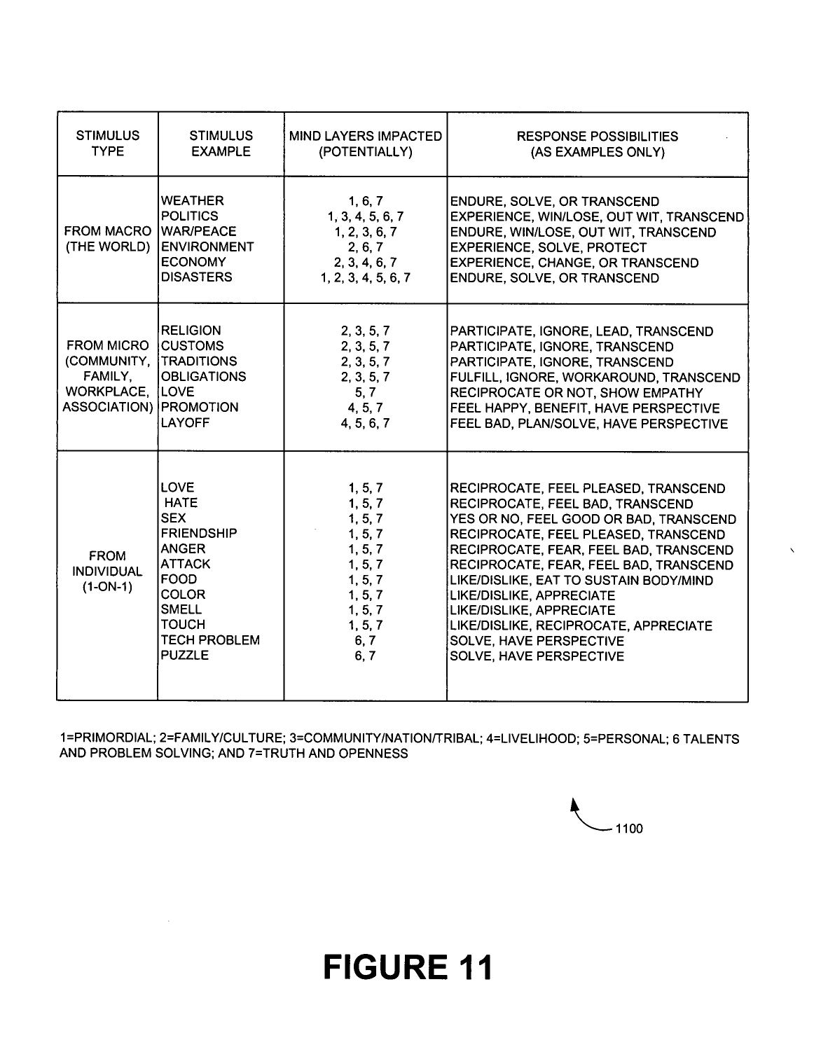

FIG. 11 is a chart view 1100 illustrating the mind layers 109 and responses associated with various stimulus types, according to one embodiment. In one embodiment, a stimulus may impact a human mind at one or more layers. For example, the truth layer and openness (layer 7) may be reached by any stimulus. A mind may take a step back and reflect on anything that is happening at any level, to calmly understand, comprehend, gain insight, etc.

In the example embodiment illustrated in FIG. 11, some of the other mind layers may be activated depending on the nature of the stimulus 114. The macro stimuli (e.g., the world) include weather, politics, war, peace, environment, economy, and disasters that may potentially impact the mind layers. For example, the stimulus 114 ‘weather’ may affect the mind layers 1, 6, and 7 and possibly result in responses 116 such as endure, solve, transcend, etc. The micro stimuli include religion, customs, traditions, obligations, etc. which may affect the mind layers 2, 3, 5, 7. The possible responses 116 generated in response to the micro stimuli include participate, lead, ignore, transcend, etc.

Further, the individual stimuli include love, hatred, sex, anger, friendship, color, food, etc. which may affect the mind layers 1, 5 and 7 resulting in responses 116 such as reciprocate, feel pleased, like, dislike, solve, appreciate, etc. For example, a stimulus 114 may be tagged to the mind layers (e.g., that it may impact) as well as its origin (e.g., macro, micro, and/or specific individual, etc.) for the purposes of computer modeling and simulation. Further, a file containing many stimuli 114 may need to be created and tagged since computer modeling is about precisely linking stimuli 114, connotations, personality, and responses 116. For example, the stimulus 114 may include commonly occurring ones as well as those that are being specifically investigated in a particular computer simulation study.

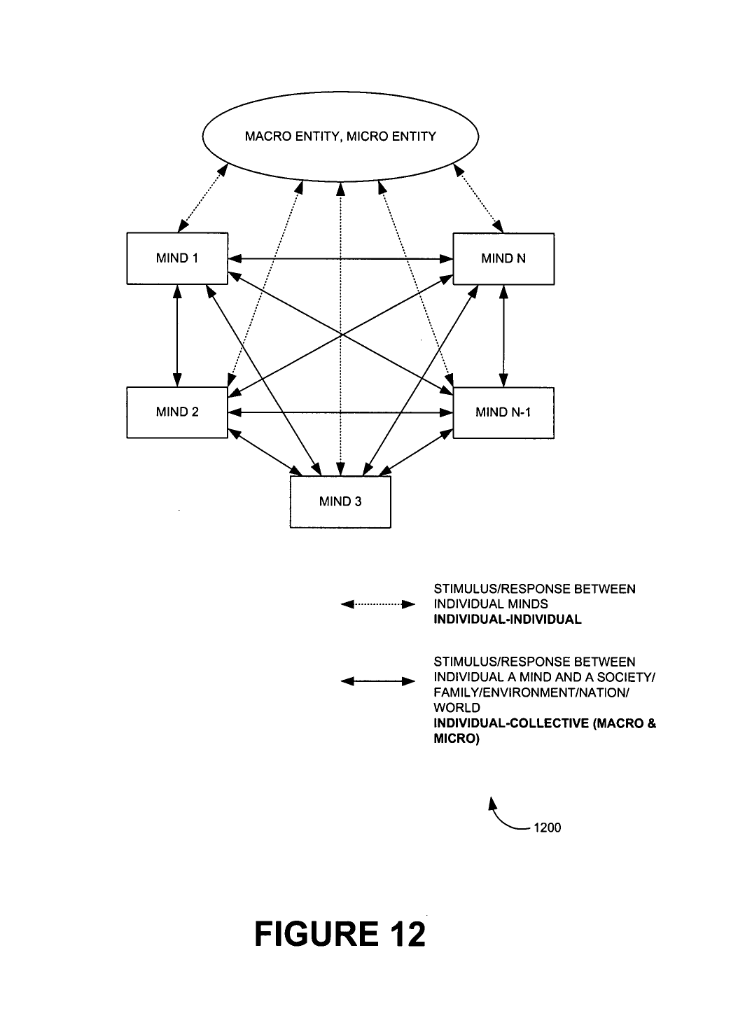

FIG. 12 is a network diagram 1200 of stimulus-response mappings between a macro entity 124, a micro entity 126 and a network of individual representations 122, according to one embodiment. Particularly, FIG. 12 illustrates a mind 1, a mind 2, a mind 3, a mind N-1, a mind N, the network and external stimuli, according to one embodiment.

For example, the number of individual representations 122 in the network may be from a few to hundreds or thousands. In one embodiment, creating networks of individual representations 122 to form a group and/or society may include choosing the sample size based on statistical analysis. For example, to emulate and/or simulate the entire United States, one might need a random sample of 1,000 individuals to produce results at a certain confidence level. To emulate and/or simulate a high school of 1,500 students, a sample size of 50-100 may be sufficient.

In the example embodiment illustrated in FIG. 12, the entity representing the collective (e.g., organization, environment, family, society, nation, etc.) may be a source of macro or micro stimuli for every mind in the network 122. The collective entity is also the vessel for recording the total effect of all the responses from individual minds (e.g., collective impact of individuals on a group, society, nation, etc.). For example, the stimulus-response may be between individual minds. The stimulus-response may also be between a mind and society, family, environment, nation, world, etc.

In one embodiment, the network of individual representations 122 to form a group and society having one including a sample size may be created based on statistical analysis to obtain a desired confidence level. The confidence level may be relied through the network of individual representations 122. The network of individual representations 122 may be placed in a collective entity serving as a vessel of recording an aggregate effect of a set of responses 116 of individual minds 128A-N.

FIG. 13 is a report view 1300 illustrating responses, weighted scores, feedback, and mind modifications generated based on the external stimuli, according to one embodiment. Particularly, FIG. 13 illustrates the external stimuli, mind layer impacted by the stimuli, previous connotations, responses, intensity, weighted score, mind layers (e.g., to which feedback is sent), changes, remarks, according to one embodiment. For example, each response has an intensity score and a layer weight associated with it, a weighted score using the product of the layer weight (%) and intensity may be generated.

In one embodiment, when a mind experiences and processes a stimulus (e.g., the stimulus data 114 of FIG. 1), it may undergo change due to insight gained, knowledge gained, conditioning, etc. Insight may be transformative and may make a mind less animal, less ego-centric and more open to truth. For example, prior to an insight, a mind might believe that God has certain attributes. But after an insight, the mind may be more curious and explorative about God's attributes, rather than just believe. Knowledge can expand on the innate talents of the mind and give it more intellectual capacity.

In one embodiment, conditioning may refer to modifying the cause-effect behavior, such as through reward/punishment, praise/criticism, pleasant/unpleasant contact, etc. For example, prior to getting to know a person, a mind may have no connotations associated with that person, but may soon have connotations (e.g., good, bad, neutral, etc.) following some contact and experience with that person. For example, the layer 7 (truth and openness layer) insights may have a lack of ego-connotation and a power to transform an individual and hence will structurally alter the weights of all mind layers (e.g., increases layer 7 weight at the expense of the others, except layer 6 which remains the same).

For example, if the weight for layer 7 rises by 20% (e.g., from 0.1 to 0.12), then the incremental 0.02 will need to be deducted from the layers 1 through 5 in proportion to their weights, i.e., animal and human ego contents of the mind decrease, while openness to truth increases. The layer 6 knowledge acquisition may have no ego connotations and may simply expand the intellectual capacity of the mind through increasing the intensity of certain responses 116 in that mind layer. But stimuli-responses in the layers 2-5 modify the connotations of the mind. In one embodiment, the mind modification report illustrated in FIG. 13 may provide a trace of all the changes to an individual mind (as well as to the collective macro entities 124A-N and micro entities 126A-N) due to insights, learning or conditioning.

In the example embodiment illustrated in FIG. 13, the external stimulus 114 ‘rudeness by retail sales person’ may make an impact on a mind layer 1 (e.g., the primordial layer) having a weight 0.2. The response 116 to the stimulus 114 is anger with intensity score of −4. The weighted score of −0.8 is calculated from the product of the intensity score (−4) and the weight assign to the layer 1 (i.e., 0.2). The weighted score (e.g., in column C) is obtained from the product (e.g., C=A*B) of the layer weight (e.g., in column A) and the intensity score (e.g., in column B). Based on the responses 116 (e.g., anger) and the weight score (−0.8), feedback is provided to the layers 1 and 5. Upon providing the feedback to the layers 1 and 5, new connotation generated is dislike whereas the layer weight remains unchanged. For example, one may expect politeness from retail sales person and the mind may dislike the retail sales person next time due to rudeness.

In one embodiment, a weighted score may be generated using a product of a layer weight (e.g., the layer weight 512 of FIG. 5) and intensity (e.g., illustrated in FIG. 13) through a computer simulation that generates a time period analysis of an effect of stimuli having a summary of weighted responses that are positive responses and/or negative responses.

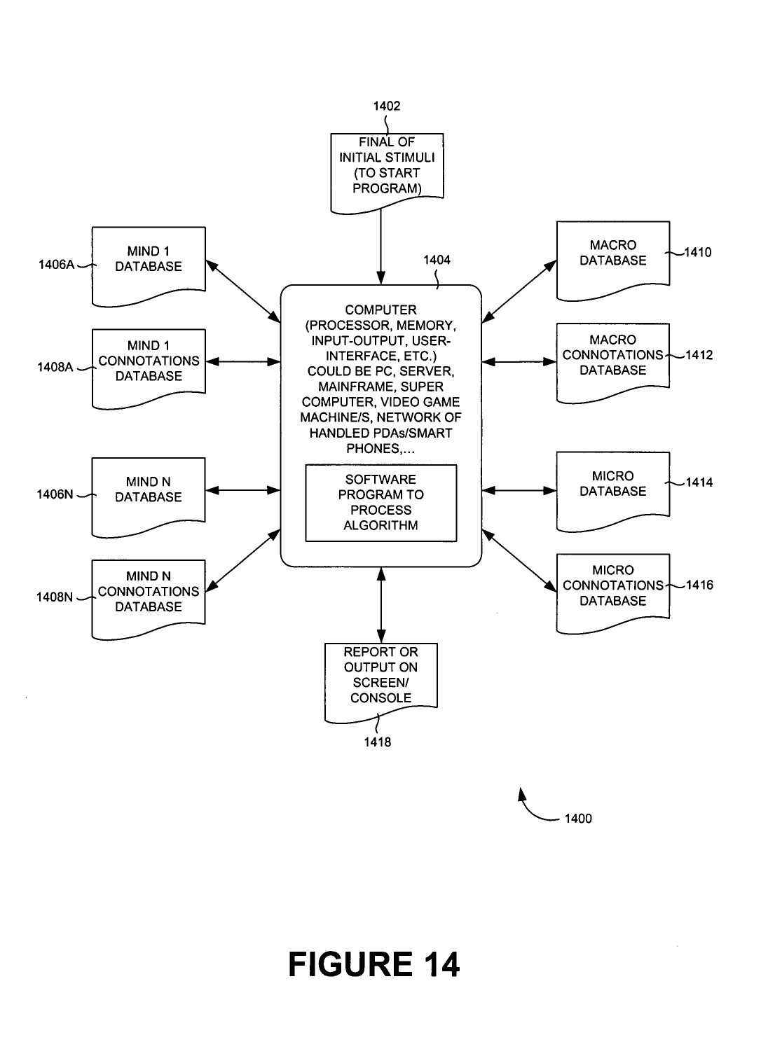

FIG. 14 is a block diagram 1400 of a computerized mind modeling simulation, according to one embodiment. Particularly, FIG. 14 illustrates a file of initial stimuli 1402, the computer 1404, mind database 1406A-N, mind connotations database 1408A-N, the macro database 1410, macro connotations database 1412, a micro database 1414, a micro connotations database 1416 and a report/output 1418, according to one embodiment.

The file of initial stimuli 1402 may be a set of data which are input to the multi-layer model during a simulation run, which represent data from an interfacing system or sub-system. The stimuli 114 may be data that cause an organism (e.g., human beings) to perform an activity and/or start a reaction. For example, the stimuli 114 may be pleasant or unpleasant, threatening or reassuring, rewarding or punishing, characterized by love or hatred or indifference, and so on. In addition, the stimulus 114 may impact a human mind at one or more layers (e.g., the layers 1-7).

The computer 1404 may include a software program to process the algorithm to model the human mind, personality and/or ego. The mind database 1406A-N may be a database containing the stimuli including commonly occurring events as well as events that are being specifically investigated in a particular computer simulation study.

The mind connotations database 1408A-N may be a database containing connotations associated with individual minds. Connotations may be the baggage of associations that comes with many things. For example, if the stimulus were, say, America being involved in some part of the world, then the word America has a set of associations depending on one's frame of mind. The word might connote power, riches, technological advancement, goodness, generosity, arrogance, hubris, imperialism, etc. For example, the mind connotations database 1408A-N may include broadly-shared, narrowly-shared, and individual-specific connotations.

The macro database 1410 may include details (e.g., layer weight, intensity, resistance to change, etc.) associated with a macro entities 124A-N such as a geographic group, a social group and/or a civic body, etc. The macro connotations database 1412 may be a database containing connotations associated with the macro entities 124A-N. The micro database 1414 may include details (e.g., layer weight, intensity, resistance to change, etc.) associated with a micro entities 126A-N such as a family, a community and/or an association, etc. The micro connotations database 1416 may be a database containing connotations associated with the micro entities 126A-N. The report or output 1418 may represent a report generated after a computer simulation run, displaying the weighted responses on a screen or console.

In one example embodiment as illustrated in FIG. 14, simulations are based upon using time intervals at which stimuli 114 or commands are sent and responses 116 are processed. These time intervals are referred to as time-steps. It is perhaps reasonable to think of human beings as experiencing stimuli 114 every one second or so. In any event, the person performing the simulation has the discretion to change the time-step and use (e.g., a millisecond, 1 second, 5 seconds, 30 seconds, 2 minutes or any such number). For example, if a time-step of 1 minute is chosen, then a simulation run lasting 6 hours would involve 360 time-steps.

In one embodiment, the score report 1418 generated may show (e.g., depending on the scope and length of the simulation run) a series of responses and their corresponding weighted scores for (a) an individual mind, (b) a group of minds (example, a community or society), or (c) the nation or world at large.

Viewing such a report, one may glean a set of patterns of experiences that a particular mind or group or nation is having, for example- How much anger is there in a person or group? How much love? How much tit-for-tat? How much insight and compassion? How much technical problem solving? How much preference for a particular food or music item? Also, given that feedback and mind modification are involved, how much change over time in the responses and their scores? and the like.

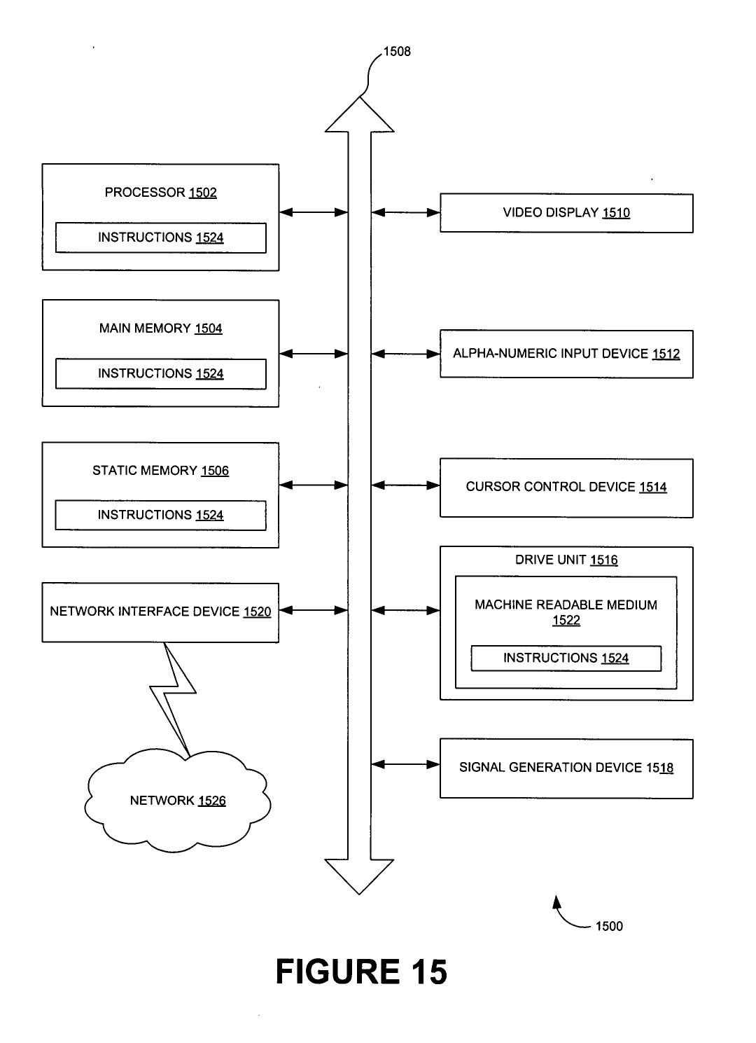

FIG. 15 is a diagrammatic system view 1500 of a data processing system in which any of the embodiments disclosed herein may be performed, according to one embodiment. Particularly, the diagrammatic system view 1500 of FIG. 15 illustrates a processor 1502, a main memory 1504, a static memory 1506, a bus 1508, a video display 1510, an alpha-numeric input device 1512, a cursor control device 1514, a drive unit 1516, a signal generation device 1518, a network interface device 1520, a machine readable medium 1522, instructions 1524 and a network 1526, according to one embodiment.

The diagrammatic system view 1500 may indicate a personal computer and/or the data processing system in which one or more operations disclosed herein are performed. The processor 1502 may be a microprocessor, a state machine, an application specific integrated circuit, a field programmable gate array, etc. (e.g., Intel® Pentium® processor). The main memory 1504 may be a dynamic random access memory and/or a primary memory of a computer system.

The static memory 1506 may be a hard drive, a flash drive, and/or other memory information associated with the data processing system. The bus 1508 may be an interconnection between various circuits and/or structures of the data processing system. The video display 1510 may provide graphical representation of information on the data processing system. The alpha-numeric input device 1512 may be a keypad, a keyboard and/or any other input device of text (e.g., a special device to aid the physically handicapped).

The cursor control device 1514 may be a pointing device such as a mouse. The drive unit 1516 may be the hard drive, a storage system, and/or other longer term storage subsystem. The signal generation device 1518 may be a bios and/or a functional operating system of the data processing system. The network interface device 1520 may be a device that performs interface functions such as code conversion, protocol conversion and/or buffering required for communication to and from the network 1526.

The machine readable medium 1522 may provide instructions on which any of the methods disclosed herein may be performed. The instructions 1524 may provide source code and/or data code to the processor 1502 to enable any one or more operations disclosed herein.

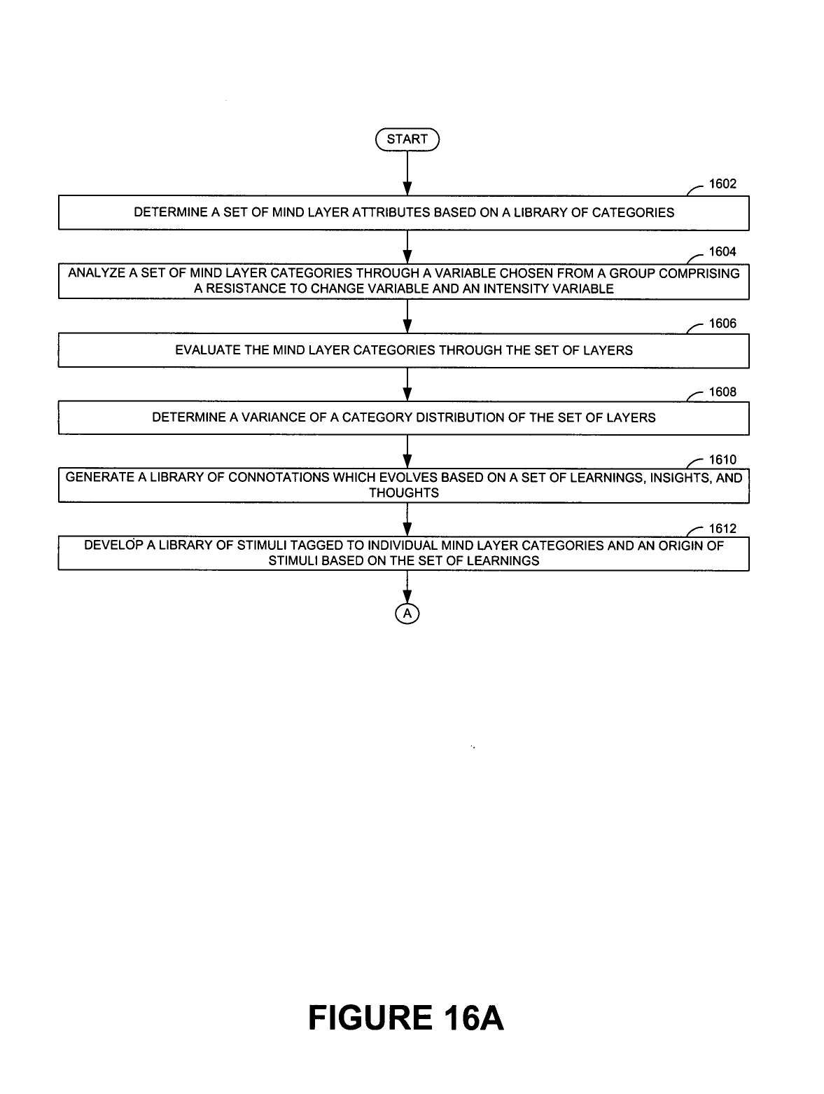

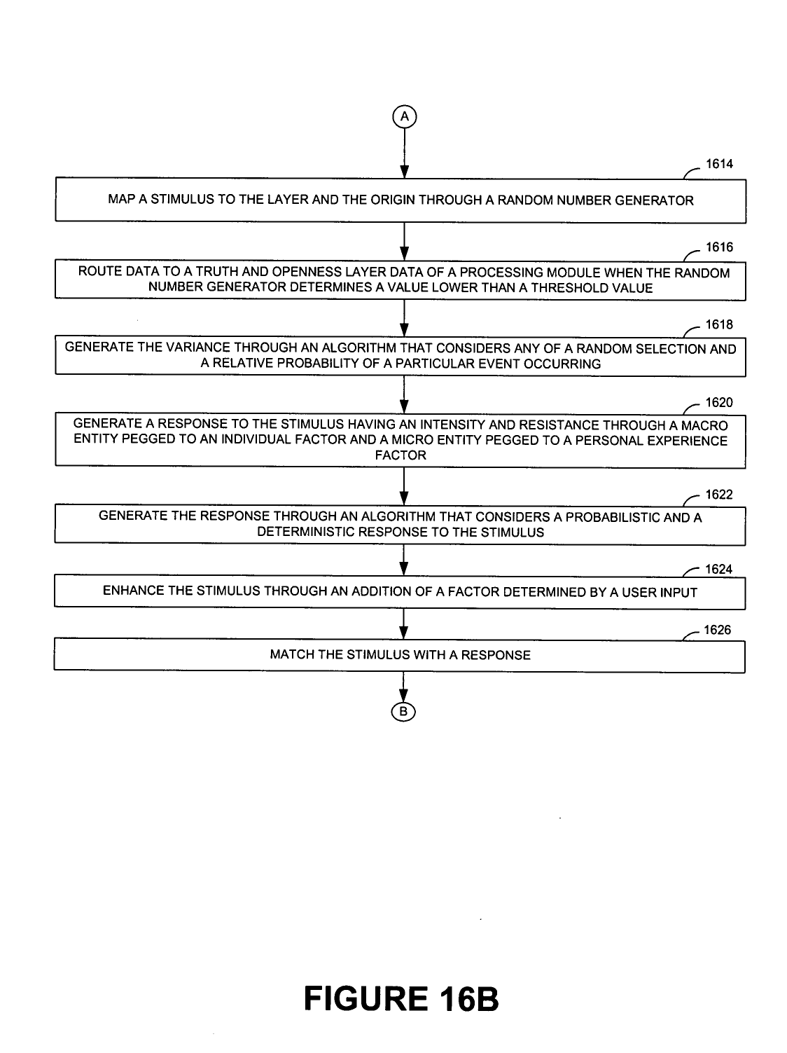

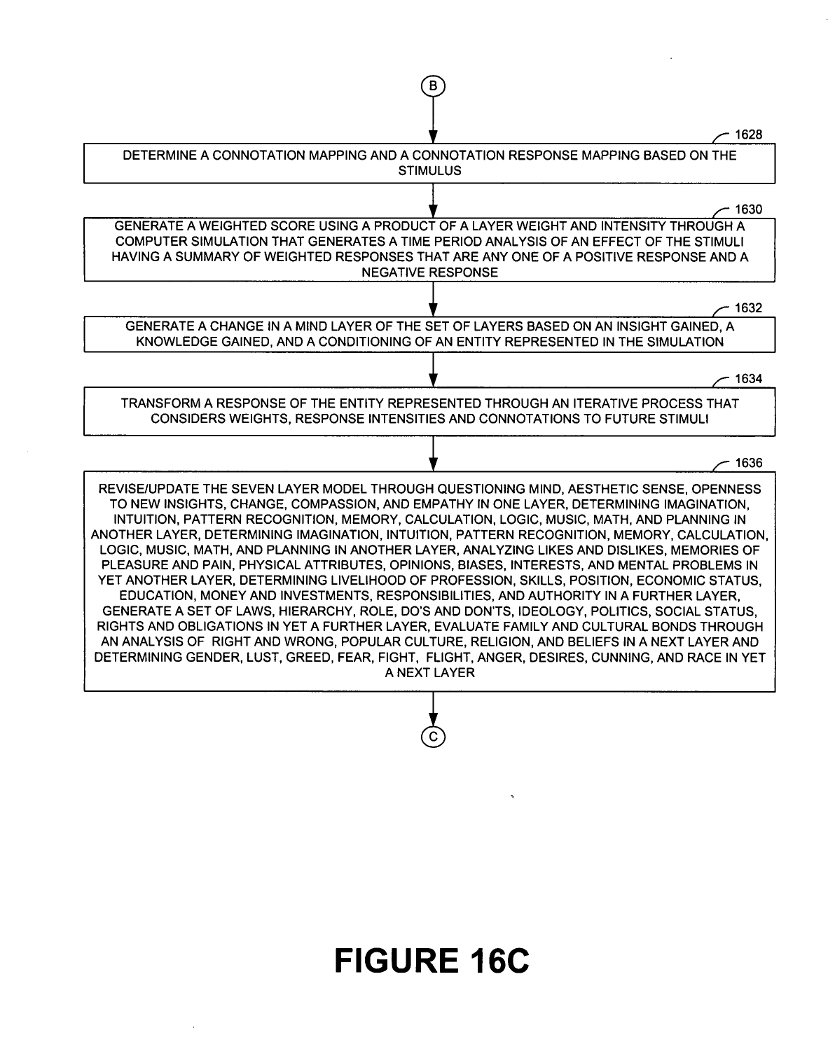

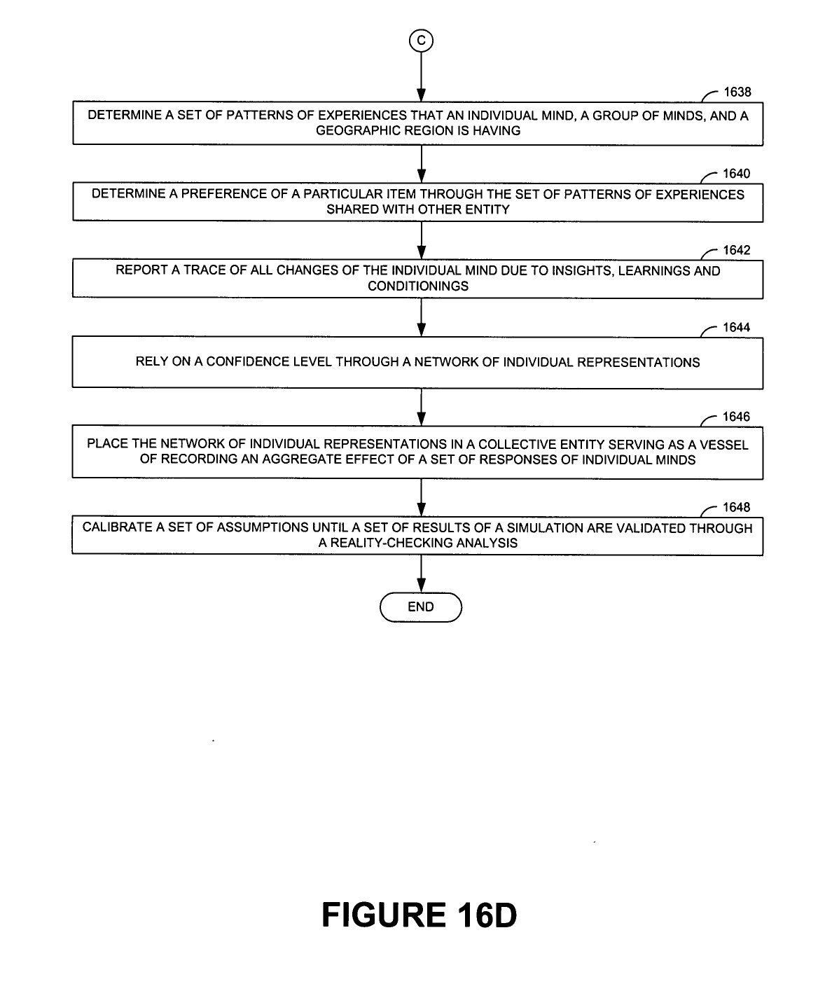

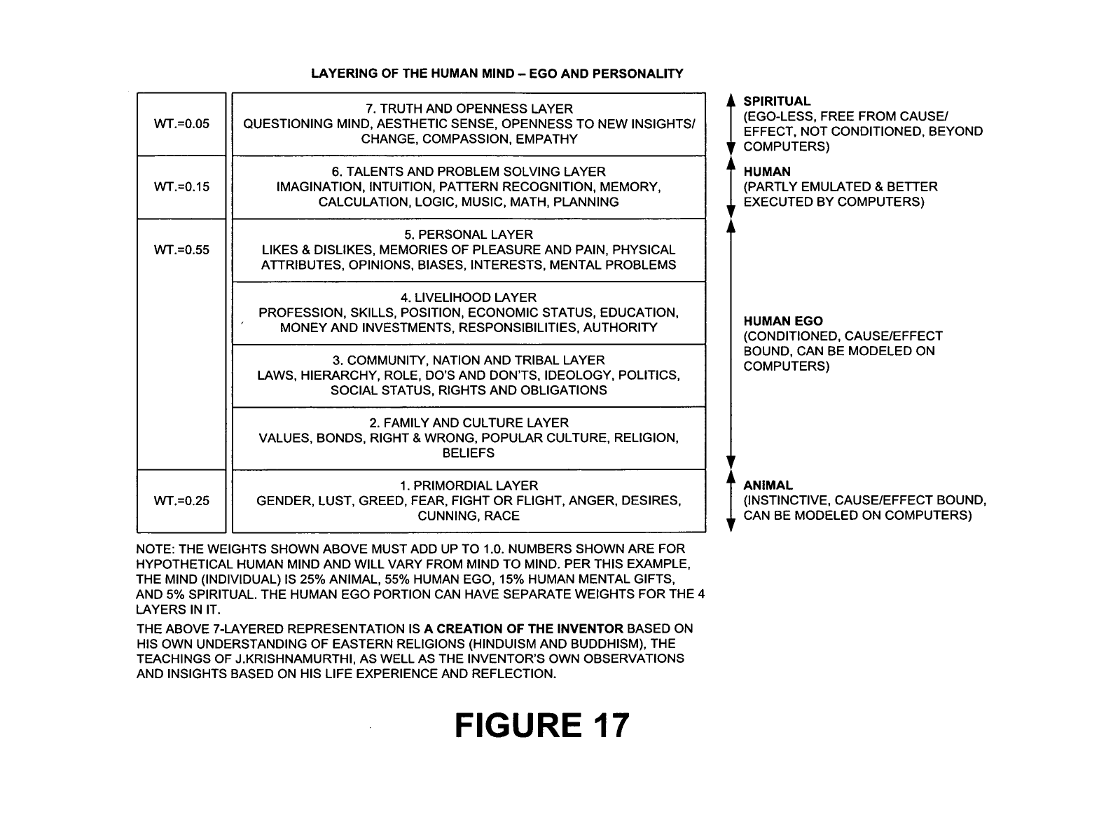

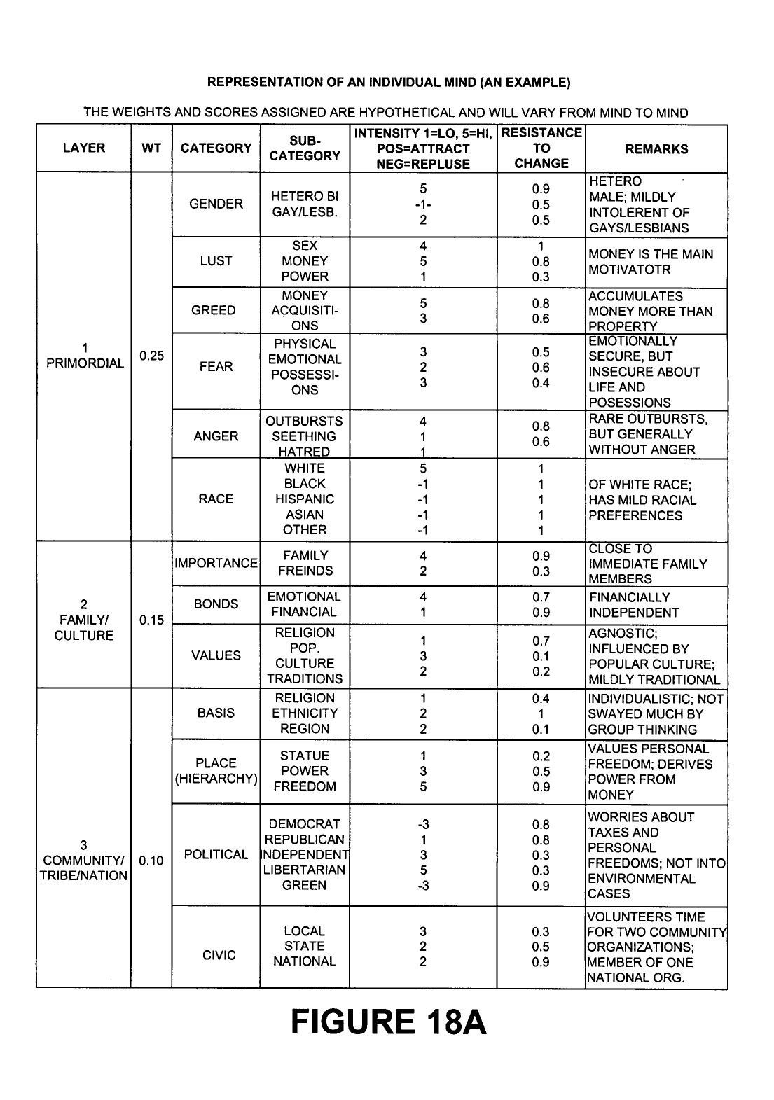

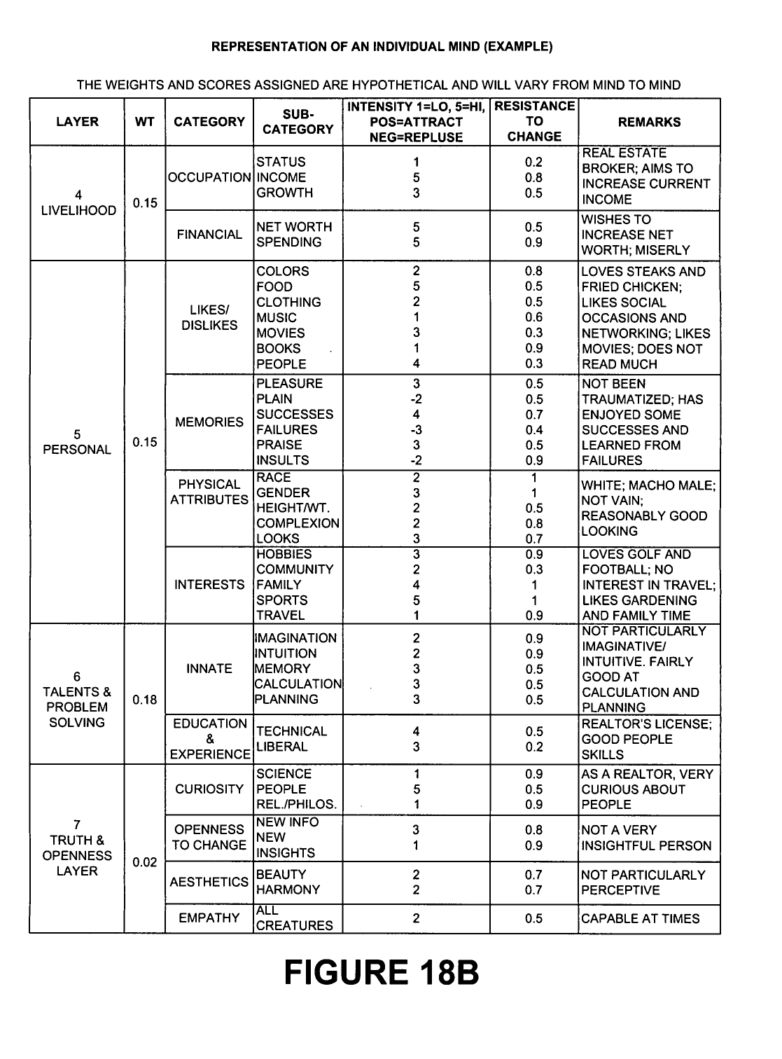

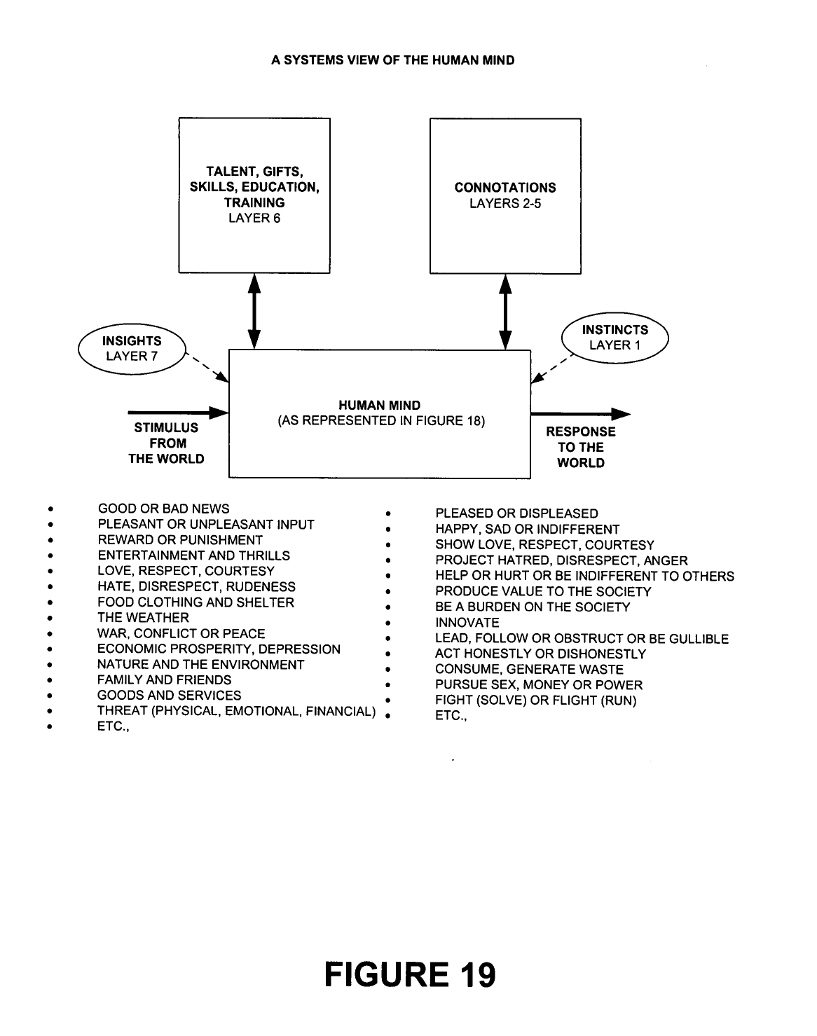

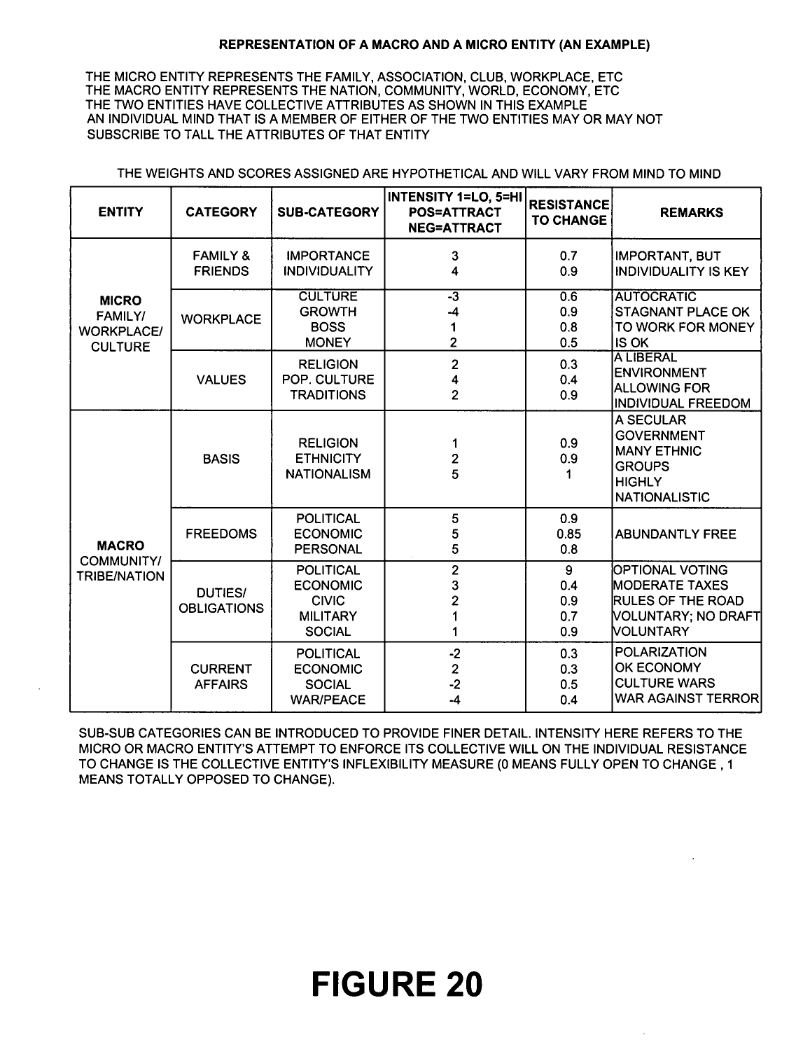

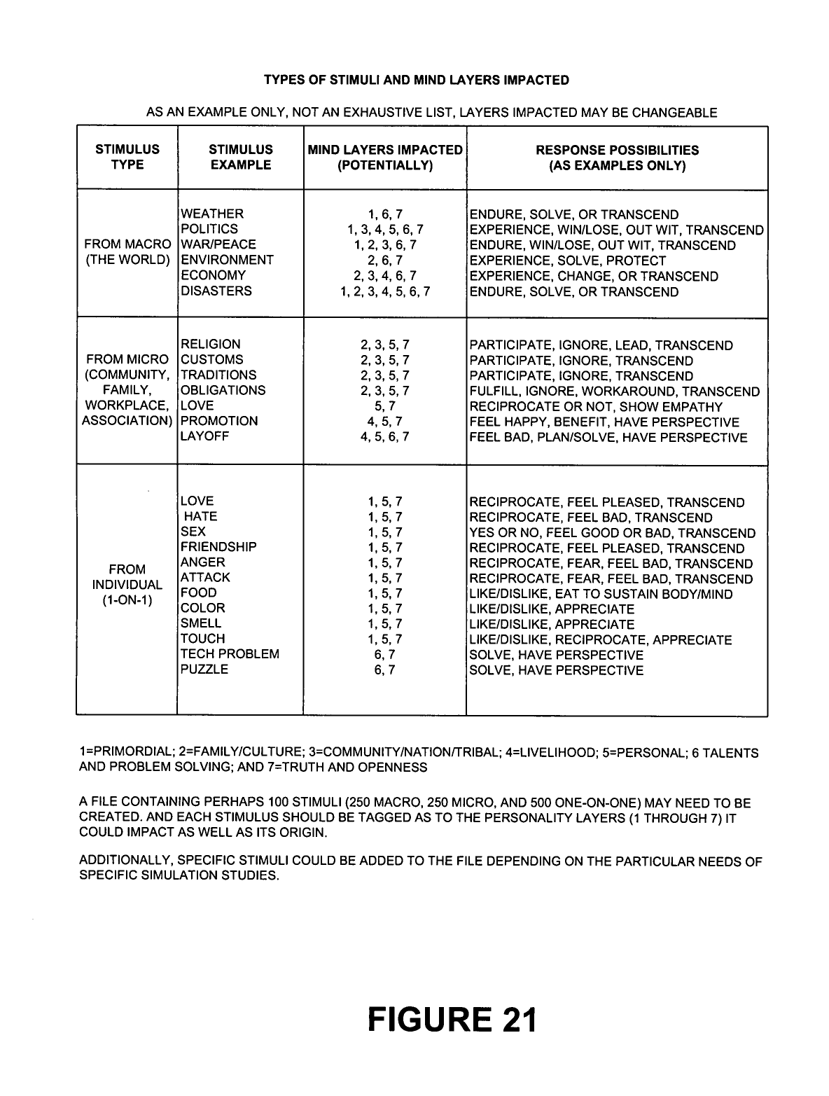

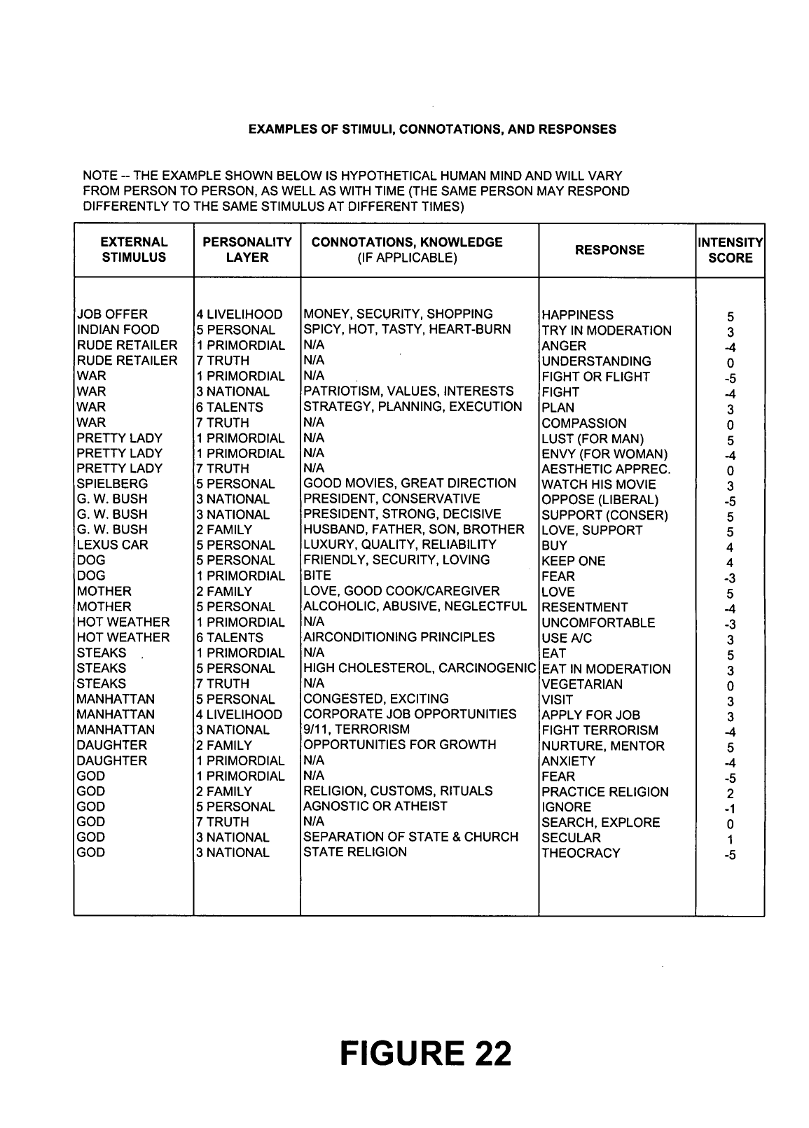

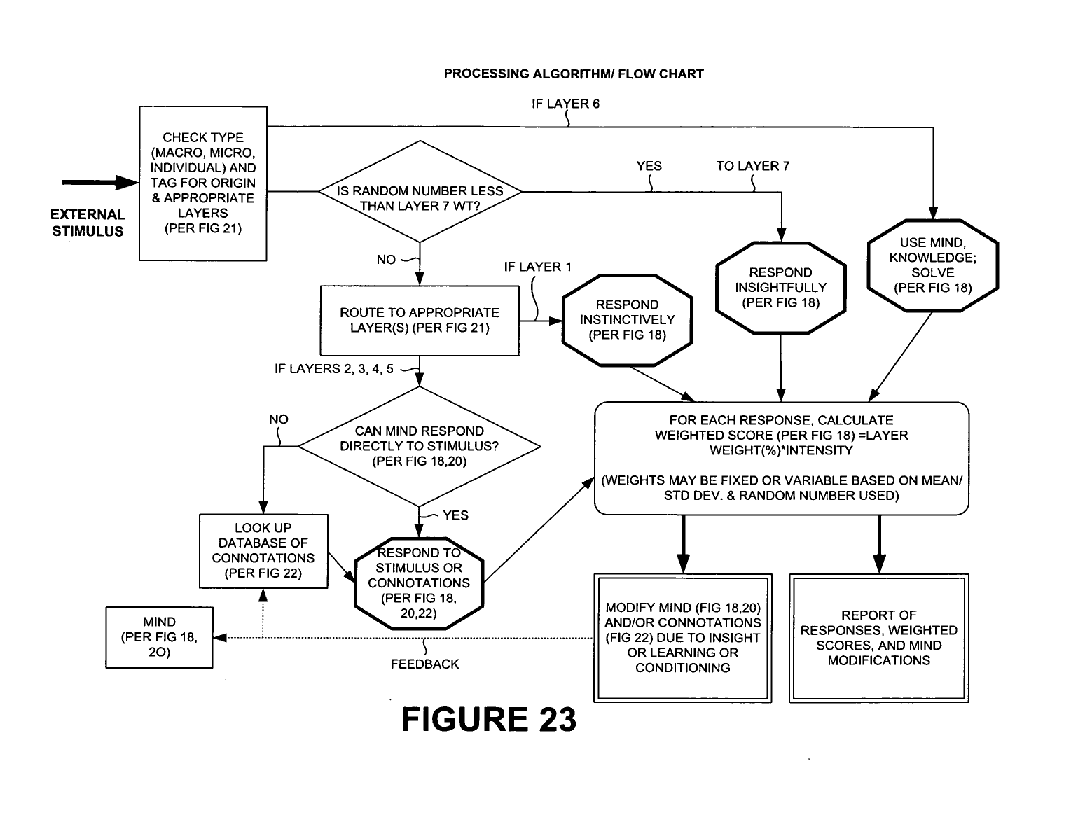

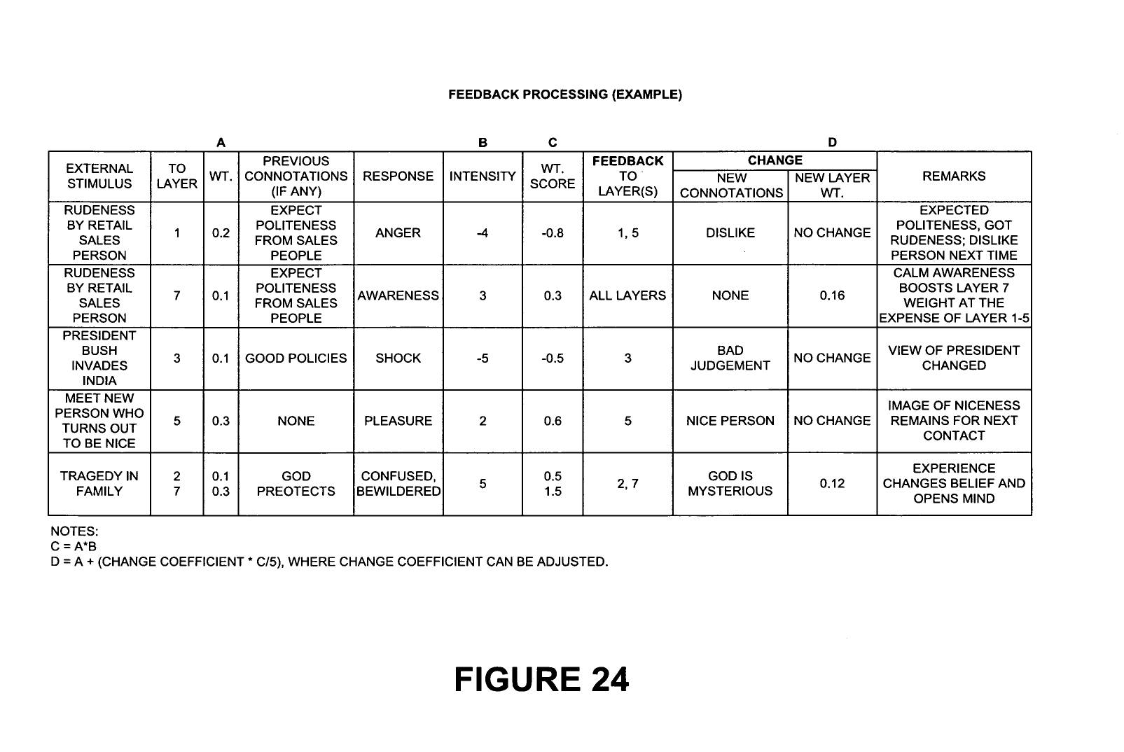

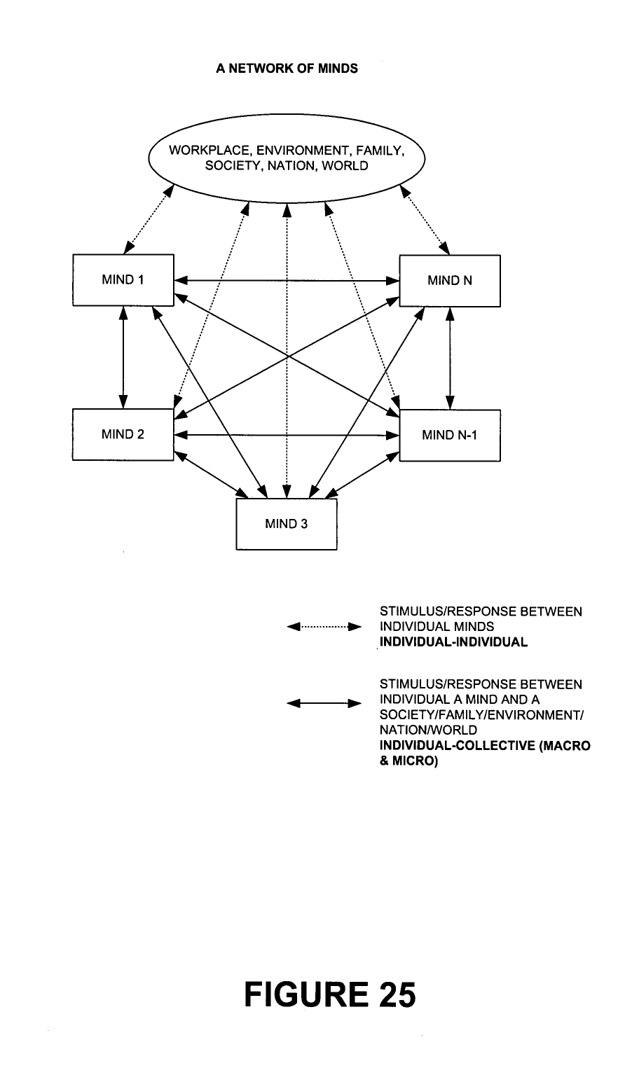

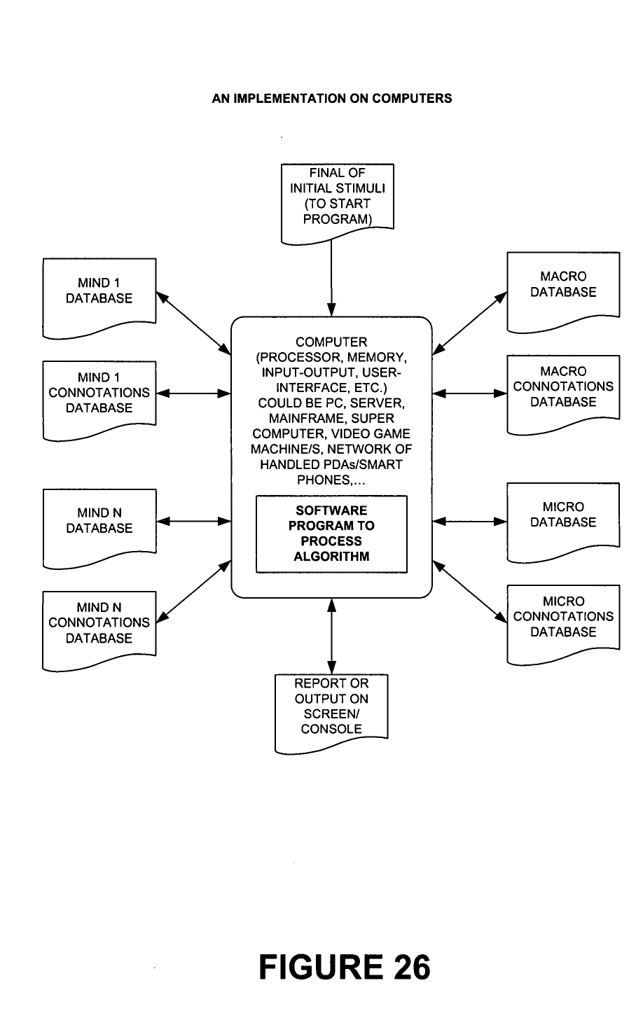

FIG. 16A is a process flow of a method of a personality test, according to one embodiment. In operation 1602, a set of mind layer attributes may be determined (e.g., using the mind module 204 of FIG. 2) based on a library of categories (e.g., the category database 214 of FIG. 2). In operation 1604, a set of mind layer categories (e.g., the mind layer categories 110 of FIG. 1) may be analyzed (e.g., through the assessment module 206 of FIG. 2) through a variable chosen from a group including a resistance to change variable and an intensity variable. In operation 1606, the mind layer categories 110 may be evaluated (e.g., using the evaluation module 208 of FIG. 2) through a set of layers (e.g., the mind layers 109 of FIG. 1 and the layers 510 of FIG. 5).

In operation 1608, a variance of a category distribution of the set of layers 109 may be determined. In operation 1610, a library of connotations (e.g., the connotations database 308 of FIG. 3) which evolves based on a set of learnings, insights and thoughts may be generated (e.g., using the connotations module 306 of FIG. 3). In operation 1612, a library of stimuli (e.g., the stimuli database 304 of FIG. 3) tagged to individual mind layer categories 110 and an origin of the stimuli (e.g., the stimulus data 114 of FIG. 1) may be developed (e.g., using the stimulus module 302 of FIG. 3) based on the set of learnings.

FIG. 16B is a continuation of the process flow of FIG. 16A, illustrating additional processes, according to one embodiment. In operation 1614, a stimulus 114 may be mapped to the layer 109 and the origin through a random number generator (e.g., the random number generator 212 of FIG. 2). In operation 1616, data may be routed to a truth and openness layer data (e.g., the truth and openness layer (layer 7) of FIG. 5) of a processing module (e.g., the processing module 108 of FIG. 1) when the random number generator 212 determines a value lower than a threshold value. In operation 1618, the variance may be generated (e.g., through the variance module 210 of FIG. 2) through an algorithm (e.g., illustrated in FIG. 6) that considers any of a random selection and a relative probability of a particular event occurring.

In operation 1620, a response (e.g., the response data 116 of FIG. 1) to the stimulus 114 having an intensity and resistance may be generated (e.g., through the response module 310 of FIG. 3) through a macro entity pegged to an individual factor and/or a micro entity pegged to a personal experience factor. In operation 1622, the response 116 may be generated through an algorithm that considers a probabilistic and/or a deterministic response to the stimulus 114. In operation 1624, the stimulus 114 may be enhanced (e.g., using the stimulus module 302 of FIG. 3) through an addition of a factor determined by a user input. In operation 1626, the stimulus 114 may be matched (e.g., through the mapping module 312 of FIG. 3) with a response 116.

FIG. 16C is a continuation of the process flow of FIG. 16B, illustrating additional processes, according to one embodiment. In operation 1628, a connotation mapping and a connotation response mapping may be determined (e.g., through the client module 104 of FIG. 1) based on the stimulus 114. In operation 1630, a weighted score may be generated (e.g., using the mind modeling module 102 of FIG. 1) using a product of a layer weight (e.g., the layer weight 512 illustrated in FIG. 5) and intensity through a computer simulation that generates a time period analysis of an effect of the stimuli having a summary of weighted responses that are a positive response and/or a negative response. In operation 1632, a change in a mind layer of the set of layers 109 may be generated (e.g., using the mind modeling module 102 of FIG. 1) based on an insight gained, a knowledge gained, and a conditioning of an entity represented in the simulation. In operation 1634, a response 116 of the entity represented through an iterative process that considers weights, response intensities and/or connotations to future stimuli may be transformed (e.g., using the mind modeling module 102 of FIG. 1).

In operation 1636, the seven layer model may be revised and/or updated (e.g., using the layer module 202 of FIG. 2) through questioning mind, aesthetic sense, openness to new insights, change, compassion, and empathy in one layer (e.g., the truth and openness layer (layer 7) of FIG. 5), determining imagination, intuition, pattern recognition, memory, calculation, logic, music, math, and planning in another layer (e.g., the talents and problem solving layer (layer 6) of FIG. 5), analyzing likes and dislikes, memories of pleasure and pain, physical attributes, opinions, biases, interests, and mental problems in yet another layer (e.g., the personal layer (layer 5) of FIG. 5), determining livelihood of profession, skills, position, economic status, education, money or investments, responsibilities, and authority in a further layer (e.g., the livelihood layer (layer 4) of FIG. 5), generating a community layer having a set of laws, hierarchy, role, do's and don'ts, ideology, politics, social status, rights and obligations in yet a further layer (e.g., the community, nation and tribal layer (layer 3) of FIG. 5), evaluating family and cultural bonds through an analysis of right and wrong, popular culture, religion, and beliefs in a next layer (e.g., the family and culture layer (layer 2) of FIG. 5), and determining gender, lust, greed, fear, fight or flight, anger, desires, cunning, and race in yet a next layer (e.g., the primordial layer (layer 1) of FIG. 5).

FIG. 16D is a continuation of the process flow of FIG. 16C, illustrating additional processes, according to one embodiment. In operation 1638, a set of patterns of experiences that an individual mind 128, a group of minds, and/or a geographic region is having may be determined. In operation 1640, a preference of a particular item may be determined through the set of patterns of experiences shared with other entity. In operation 1642, a trace of all changes of the individual mind due to insights, learnings and conditionings may be reported.

In operation 1644, a confidence level may be relied through a network of individual representations (e.g., the network of individual representations 122 of FIG. 1). In operation 1646, the network of individual representations 122 may be placed in a collective entity serving as a vessel of recording an aggregate effect of a set of responses of individual minds 128A-N. In operation 1648, a set of assumptions may be calibrated until a set of results of a simulation are validated through a reality-checking analysis.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structures and methods may be embodied using transistors, logic gates, and electrical circuits (e.g., Application Specific Integrated circuitry (ASIC) and/or in Digital Signal Processor (DSP) circuitry). For example, the client module 104, the processing module 108, the layer module 202, the mind module 204, the assessment module 206, the evaluation module 208, the variance module 210, the livelihood module 216, the community module 218, the social hierarchy module 220, the emotion module 222, the stimulus module 302, the connotations module 306, the response module 310, the mapping module 312 and other modules of FIGS. 1-16 may be enabled using a client circuit, a processing circuit, a layer circuit, a mind circuit, a assessment circuit, a evaluation circuit, a variance circuit, a livelihood circuit, a community circuit, a social hierarchy circuit, an emotion circuit, a stimulus circuit, a connotations circuit, a response circuit, a mapping circuit and other circuits using one or more of the technologies described herein.

In one example embodiment, the use of computers to model the human mind (“artificial intelligence”) is often based on narrowing the search space for the computer by employing heuristics and then using the raw power of calculation of the computer within the search space. This is the basis of the computer that plays chess at the world championship level, for example.

But the human mind functions in myriad ways, displaying capabilities and frailties beyond memory or calculating power. The human mind features insights, imagination, intuition, emotion, rational and irrational behavior, sanity and insanity, varying kinds of psychological disorders, biases, prejudices, likes and dislikes, fears and insecurities, hopes and aspirations, dreams and fantasies, etc.

In short, the human mind has a consciousness with an EGO at the center (the center is the ego). And it displays a unique PERSONALITY that differentiates it from other human minds.

1.0 MODELING THE EGO AND PERSONALITY ON A COMPUTER: A computer model that emulates/simulates the behavior of the human mind can be of great help in many areas: Emulating and simulating the behavior of an individual; emulating and simulating the behavior of a group of individuals with different egos and personalities; emulating and simulating the behavior of societies, tribes, religious followers, nations and so on. Emulation means representing as accurately as possible or desirable the functionality and features of the human mind. Simulation means doing “what ifs” using computers, changing variables, and examining the changing behavior of the mind and its interactions with other minds. Such emulations and simulations can be of great help to researchers in sociology, psychology, anthropology, religion, business, marketing, organizational behavior, and so on. The simulations may lead to insights regarding the behavior of individuals and groups, the effect of changing certain variables (such as through training, education, advertising, societal changes, economic circumstances, brute force, etc.), the relative importance of those variables, and specific actions that one might take to achieved desired results. Educators, politicians, business and religious leaders, community action groups and others may use the results and insights to develop their own messages and actions. Game developers could also use this invention.

2.0 HOW TO MODEL: Eastern religious traditions as well as the inventor's own observations have shed light on what constitute the ego and the personality. This invention uses those insights to develop a computer model for the ego and personality.

At the root of self-centered (or ego-centric) consciousness is the feeling of SEPARATENESS from the rest of the universe. This sense of separateness co-exists with a feeling of COMMONNESS based on belonging to the same gender, race, family, age-group, tribe, religion, society, community organization, social or economic stratum, nation, or other affiliation. Thus, each of us is divided from and united with others at the same time. For example, U.S. citizens have their nation as a commonality, but may be divided based on political affiliation (Republican, Democrat), religious affiliation (Catholic, Baptist, Jewish, etc.). One may be united with tennis players around the world based on a passion for the game, but divided based on the nation one lives in. At the primordial level, we are united by our common passions: fear, lust, greed, anger, survival instinct, and so on. But these also serve to divide because humans compete with one another based on the primordial traits. Gender and lust both attract and divide.

A human being is also made unique by the particular experiences that one has had in life, the particular conditioning or education or programming or brainwashing that one has received, etc. These particular experiences could be of pleasure and pain, delights and traumas, adulations and insults, and so on. The human mind wants to pursue pleasure and avoid pain, seek praise and avoid humiliation. But the mind can also exhibit uniqueness for no obvious reason, such as with likes and dislikes, or with talents. One may like or dislike a certain color, food, dress, beverage, person, object, artwork, etc., for no apparent reason. Likewise, unique talents can surface mysteriously.

The human mind can then be pictured as a LAYERED entity, primordial at the base and highly open and free near the top. At each level, the mind is united with and divided from other minds. Lines of division crisscross the landscape, uniting us in some ways and dividing us in others. The sum total of all the layers could be called a particular human mind's PERSONALITY, while the EGO is the center, the thought that identifies itself with all the elements of the personality, as in I, ME, and MINE. A computer model of the human ego and personality must capture this crisscrossed landscape of unities and divisions that finally result in the single individual, a group, a tribe, a society, a nation, or some other affiliation.

2.1 MODEL OF THE HUMAN MIND/PERSONALITY/EGO: FIG. 17 shows that the human mind is made up of seven layers. However, different human beings emphasize different layers. Some live more at the primordial or animal level (driven by base impulses), a few others are governed by the top-most layer (truth seeking), some have enormous talent and gift of mind, and the rest are in between in various combinations. The model assigns a different weight to each level with the total of all forced apportioning of 1 is to ensure a soul-searching understanding of each mind and the relative proportions of the various elements of its personality. Different minds will have to be assigned different weights for each layer. For example, people living in America, an individualistic society, can be expected to have a higher weight for the Personal layer (5) versus someone living in Iraq or Saudi Arabia or Japan (where individuality is frowned upon) who might be assigned a higher weight for the Community or Tribal Layer (3). A particularly vain person, with a lot of emphasis on his/her physical attributes (looks, etc.), with strong likes and dislikes, will also have a higher weight attached to the Personal layer (5) than someone who is self-effacing and easy-going. A Socrates, a Plato, or an eastern mystic will be heavily weighted in the top-most Truth and Openness layer (7), while Isaac Newton would be weighted heavily in both the top-most (7) layer and in the Talents layer (6). Conversely, a hardened criminal under the grip of base impulses would be weighted more heavily in the Primordial layer (1).

FIG. 18 shows a more detailed breakdown of the 7 Layers into Categories and Sub-Categories. Such a representation of the individual mind would vary from mind-to-mind in the weights attached to each Category or Sub-Category. The score (1 to 5 scale) shown for each Sub-Category is a measure of response intensity and to be used in emulations/simulations. A positive value shows attraction, a negative value repulsion/aversion. The resistance to change is an indicator of how inflexible a person is (0 is completely open to change, 1 is totally opposed to change). This will vary with each person by layer, category, sub-category and sub-sub-category. An individual may be open to changing their travel preferences, but totally opposed to changing their religious preferences. Some people are more open to new things than others.

This representation of the human mind depicts an idea of the inventor. It is a framework and an approach. But the details can be refined in the following ways:

Further breakdown (another column) can be added within each Sub-Category to more finely characterize each unique mind. For example, if a Sub-Sub-Category were shown, food preferences in the Personal layer (5) can be broken down into Chinese, Continental, Japanese, Italian, Indian, vegetarian, etc. Likewise color preferences can be broken into the various rainbow colors and individual preferences for each color can be noted. In the Livelihood layer (4), more detail can be shown regarding the particular profession (law, engineering, medicine, clerical, blue-collar, farm worker, etc.), and status can be shown as upper or lower management, individual contributor, etc.

The idea of CONNOTATIONS can be introduced. Some items in the Sub-Category or Sub-Sub-Category come with heavy baggage. A profession such as Used Car Salesman means something to people (rightly or wrongly). Likewise, a nationality such as American has many connotations: super-power, advanced, arrogant, etc. A Harvard education has its connotations, as does being of the brown (or any) race.

The showing of Layers, Categories, Sub-Categories, Sub-Sub-Categories, etc., can be refined and adjusted based on research by psychologists/sociologists/others, using elaborate studies/surveys of many people. Personality tests could be given to individuals to determine each person's proportions vis-à-vis the 7 layers, as well as the individual's response (and intensity) to different kinds of stimuli or their connotations.

The weights shown can be assigned a distribution. That is, the weight can be viewed as the mean for the layer with a standard deviation around it. A very consistent person with predictable behavior will have a lower standard deviation than an inconsistent person given to wild swings in behavior patterns. In a computer simulation, a random number generator could be used to produce varying weights based on the mean and standard deviation.

2.2 A SYSTEMS VIEW OF THE MIND: The human mind can be modeled as a system (FIG. 19). Each mind is subject to stimuli from the world, from family and friends, from other individuals, groups, the environment or the world at large. These stimuli can be pleasant or unpleasant, threatening or reassuring, rewarding or punishing, characterized by love or hatred or indifference, and so on.

Each mind receives these stimuli, processes them at some level (Layer), uses connotations where applicable, and then responds to the stimuli. The response can be one of pleasure or pain, hostility or amiability, innovation or resignation, fight or flight, consumption, act of honesty or dishonesty, pursuit of sex or money or power, and so on.

In processing the responses to stimuli, the mind acts out its own personality based on the representation in FIG. 18, FIG. 20 and FIG. 22 (connotations). The ego comes into play in that the mind responds to pleasing sensations (flattery, rewards, love) favorably and to unpleasant sensations unfavorably. Also, the ego causes the mind to remember insults for possible future vengeful acts, and to pursue gain (sex, money, power, possessions) in a self-centered way.

Such self-centered (or ego-centric) acts emanate out of every layer except the top two, the Truth and Openness layer (7) and the Talents & Problem Solving layer (6). The top layer is the one where response to external stimuli is not mechanical, not conditioned by primordial traits or past experiences or connotations. This is in fact the layer of non-response. It is where the mind quietly observes, learns and gains insights from all kinds of stimuli, sees the larger picture, and projects understanding and compassion. It is also the layer that has the power to change the personality at the other layers. The implication is that the insights into truth gained at this level (7) can change the weights and intensity scores of the levels below. The human potential for spiritual growth is derived from this layer. Without it, human beings would be hopelessly conditioned or programmed beings, incapable of responding in any way other than from past experiences, knowledge and primordial tendencies. The Talents layer (6) is not subject so much to connotations as it is to innate talent, experience, skill, education and training. This layer is not characterized by mechanical response to the extent that imagination, intuition and innate gifts are involved (all non-mechanical in nature). The Primordial layer (1) is characterized by instinctive response, while the human ego layers (2 through 5) can involve connotations; that is, a stimulus may be responded to either directly or after the connotations have been understood.

2.3 EXTERNAL STIMULI: Stimuli in the world fall into the following categories:

2.3.1 Macro Stimuli: Stimuli that come from the world or the environment. Examples include national politics, the policies of governments, the weather, environmental factors, natural disasters, war and peace, economic conditions, and so on. These affect a large number of individuals, each of who may respond similarly or differently depending on the stimulus and the individual. Every stimulus from the macro environment must be tagged to identify the specific macro entity it came from. The macro environment can be represented as an entity as shown in FIG. 20.

2.3.2 Micro Stimuli: These come from environments that are smaller and closer to the individual, such as from the family, a workplace, the community, a club or association, etc. Every stimulus from the micro environment must be tagged to identify the specific micro entity it came from. The micro environment can be represented as an entity as shown in FIG. 20.

2.3.3 Individual Stimuli: These come from another individual/entity to the mind (one-on-one). Examples include love and hate, marital issues, relationship with a friend or a pet, a sight or smell or touch, and so on. Every stimulus from an individual must be tagged to identify the specific individual it came from.

2.3.4 Stimuli and the Human Mind: A stimulus may impact a human mind at one or more layers. FIG. 21 shows some examples. The Truth layer (7) can be reached by any stimulus. That is, a mind can take a step back and reflect on anything that is happening at any level, to calmly understand, comprehend, gain insight, etc. But some of the other layers are activated depending on the nature of the stimulus, as show in FIG. 21. For purposes of computer modeling and simulation, a stimulus will need to be tagged as to the layers it would impact as well as its origin (Macro, Micro, and specific individual). Since computer modeling is about precisely linking stimuli, connotations, personality, and responses, a file containing many stimuli will need to be created and tagged. These stimuli may include commonly occurring ones as well as those that are being specifically investigated in a particular computer simulation study.

2.4 CONNOTATIONS: The mind interprets certain stimuli based on connotations, except at: the Primordial layer (1) where the response is instinctive; the Truth layer (7) where insights of unknown origin occur; and the Talents layer (6), where innate talents, skill, knowledge and training may come into play. FIG. 22 shows an example. Connotations are the baggage of associations that comes with many things. For example, if the stimulus were, say, America being involved in some part of the world, then the word America has a set of associations depending on one's frame of mind. The word might connote power, riches, technological advancement, goodness, generosity, arrogance, hubris, imperialism, etc. Likewise, the word alcohol has connotations. Some may view it as welcome relief or fun in a stressful world, others as a waste of money and corrupting influence on people's minds. In these instances, the mind responds not to the stimulus itself but to the connotations.

Connotations can be shared among a large number of people, among a small group, or be specific to an individual. For example, almost all Americans may share the same connotations about the Founding Fathers as being visionaries and freedom fighters. Some Americans may share the connotation that Reagan was a great president. An individual American may have a superstition about something (a unique, specific connotation). So, a given person's database of connotations would include broadly-shared, narrowly-shared, and individual-specific connotations.

To enable emulations/simulations of the human mind, a library of connotations (database of associations) would have to be created. For a thousand stimuli at the human ego levels (2 through 5), there may need to be 5,000 or 10,000 connotations. This is like creating a new dictionary or a thesaurus or a book of synonyms. The human mind (FIG. 18) would interact with this library of connotations, use it for interpreting external stimuli, or conversely, change the library based on new learning. For example, based on superstition, one mind might associate an eclipse with a bad omen. But upon learning the scientific fact behind an eclipse, the mind might change that ominous connotation and replace it with benign science. Thus, there is a closed loop operating between the individual mind and the connotations library.

2.5 THE PROCESSING ALGORITHM: All computer models eventually require the processing algorithm. FIG. 23 illustrates such an algorithm.

The external stimulus is first recognized for its type (FIG. 21), specific origin, and then for the one or more layers that it needs to be routed to. If Layer 6 (Talents, problem solving) is indicated, then the stimulus is routed there. Otherwise, a random number (between 0.01 and 0.99) is generated and checked to see if it is less than the weight for Layer 7 (Truth & Openness) as indicated in FIG. 18. If it is, then the stimulus is routed to Layer 7. This algorithm reflects the notion that insight is a chance occurrence. The greater the weight of Layer 7 in a particular mind, the greater the probability that the mind will be insightful and see truth. If the random number is greater than the Layer 7 weight, the stimulus is routed to the other appropriate layers (human ego and animal). After that, the stimulus is matched in one or more of the layers either directly with the responses (FIG. 18) or first with a database of connotations (FIG. 22) to then yield the response/s.

Since computers are machines and cannot infer anything on their own, the following must happen for the algorithm to work:

(a) one-to-one/many mapping/correspondence between stimulus and response/s; or

(b) one-to-one/many mapping/correspondence between stimulus and connotation/s FOLLOWED by one-to-one/many mapping between connotation and response/s.

Therefore, databases of stimuli, connotations and responses must be created first with such one-to-one/many mapping. After that, the computer simply does the matching by looking up the databases. Regarding the direction of the response, the following rules may be used: a stimulus from an individual will result in a response back to that individual; a stimulus from a micro entity (family, community, association) will result in a response back to that micro entity; and a stimulus from the macro entity (nation, world) would result in a response back to the macro entity. Exceptions to these rules (wherein a stimulus from one entity results in a response to another entity) would have to be specified separately.

Two results emerge from the flowchart/algorithm:

2.5.1 Weighted score: Since each response has an intensity score (FIG. 18) and a layer weight (FIG. 18) associated with it, a score using the product of the layer weight (%) and intensity can be generated. Thus after a computer simulation run of some length, a report can be generated showing all the weighted responses (with their positive or negative signs).

2.5.2 Feedback for Mind Modification/Transformation: When a mind experiences and processes a stimulus, it undergoes change due to: (a) insight gained; (b) knowledge gained; or (c) conditioning. Insight can be transformative in that it can

make a mind less animal, less ego-centric and more open to truth. For example, prior to an insight, a mind might believe that God has certain attributes. But after an insight, the mind may be more curious and explorative about God's attributes, rather than just believe. Knowledge can expand on the innate talents of a mind and give it more intellectual capacity. Conditioning means modifying the cause-effect behavior, such as through reward/punishment, praise/criticism, pleasant/unpleasant contact, etc. For example, prior to getting to know a person, a mind may have no connotations associated with that person, but may soon have connotations (good, bad, neutral) following some contact and experience with that person.

In this illustrative algorithm, feedback works by using the weighted score generated for a stimulus to go back and alter the mind (FIGS. 18, 20, 22) by changing the weights, response intensities or connotations to be used for future responses. The assumption is that Layer 7 (Truth) insights have the power to transform an individual and hence will structurally alter the weights of all layers (increases Layer 7 weight at the expense of the others except Layer 6 which remains the same). For example, if the weight for Layer 7 rises by 20% from 0.1 to 0.12, then the incremental 0.02 will need to be deducted from Layers 1 through 5 in proportion to their weights. That is, animal and human ego contents of the mind decrease, while openness to truth increases. Layer 6 knowledge acquisition has no ego connotations and simply expands the intellectual capacity of the mind by increasing the intensity of certain responses in that layer. But stimuli-responses in Layers 2-5 modify the connotations of the mind. FIG. 24 shows examples.

Resistance to change is incorporated in the following way: A random number (between 0 and 1) is drawn. If it is greater than the resistance to change, the change is allowed. Otherwise, the change is resisted (disallowed). This reflects the notion that change is a chance occurrence. The less the resistance to change, the greater the probability that change will occur.

2.6 INTERPRETING REPORTS: The score report generated above may show (depending on the scope and length of the simulation run) a series of responses and their corresponding weighted scores for (a) an individual mind; (b) a group of minds (example, a community or society); or (c) the nation or world at large. Viewing such a report, one may glean patterns of experiences that a particular mind or group or nation is having. How much anger is there in a person or group? How much love? How much tit-for-tat? How much insight and compassion? How much technical problem solving? How much preference for a particular food or music item? Also, given that feedback and mind modification are involved, how much change over time in the responses and their scores?

The mind modification report can provide a trace of all the changes to an individual mind (as well as to the collective macro and micro minds) due to insights, learning or conditioning.

3.0 SETTING UP A NETWORK OF MINDS FOR SIMULATION: shows a network of minds. The number of individual minds in the network may be 1,2, a few, many, or in the hundreds or thousands. In creating networks of such individual representations to form a group or society, one could choose the sample size based on statistical analysis. For example, to emulate/simulate the entire United States, one might need a random sample of perhaps 1,000 individuals (1,000 FIGS. 18 and 22 representations) to produce results at a certain confidence level. To emulate/simulate a high school of 1,500 students, perhaps a sample size of 50-100 will suffice. In the network shown, the entity representing the collective (organization, environment, family, society, nation) is a source of macro or micro stimuli for every mind in the network. The collective entity is also the vessel for recording the total effect of all the responses from individual minds (collective impact of individuals on a group, society, or nation).

3.1 AN IMPLEMENTATION USING COMPUTERS: FIG. 26 is an example of how a computer model/emulation/simulation may be executed using computers.

3.2 TIME-STEP FOR SIMULATION: Simulations are based upon using time intervals at which stimuli or commands are sent and responses are processed. These time intervals are referred to as time-steps. It is perhaps reasonable to think of human beings as experiencing stimuli every one second or so. In any event, the person performing the simulation has the discretion to change the time-step and use, say, a mili-second, 1 second, 5 seconds, 30 seconds, 2 minutes or any such number. If for example a time-step of 1 minute is chosen, then a simulation run lasting 6 hours would involve 360 time-steps.

3.3 NUMBER OF SIMULTANEOUS STIMULI: How many stimuli does a human mind experience or process every time-step? One? Two? Five? Or more? Also, how are these divided between macro, micro and individual stimuli? For example, even as a mind is interacting with another mind (individual stimuli), it could also be experiencing the weather (a macro stimulus) and be mindful of some tension in the family (a micro stimulus). The person running the simulation has to decide how many stimuli and their types (macro, micro and individual) are used every time-step.

3.4 CALIBRATING: A computer model/emulation is a lot like tuning a musical instrument. Every assumption can be adjusted and re-adjusted, and even the processing algorithm modified, until the results of the emulation are roughly validated by reality checks. Once a computer model/emulation is thus validated, it can be used for simulations (that is, for changing various variables and gauging the overall impact). The various assumptions that need to tuned and adjusted include (but not limited to): layer weights, responses and intensities in FIGS. 18, 20; the standard deviations around these weights (depending on the individual); the resistance to learning and change; the database of connotations in FIG. 22 & responses; the algorithms in FIGS. 23 and 24; simulation time-step; number and types of simultaneous stimuli; simulation run-time, etc.

4.0 EXAMPLES OF APPLICATIONS: The following is a partial list of the types of uses that the computer model/emulation/simulation can be put to:

Simulation of a family of 2 adults, 3 children and 1 dog (yes, even a dog can be represented using FIG. 18 and FIG. 22!!). The community can be represented as a backdrop entity (micro stimuli). The results can show responses, the scores, changes over time, and the impact of changing specific variables.

Simulation of a couple and their marital interactions. The effect of marital counseling to overcome specific problems can be simulated and understood. Micro stimuli like job stress can be included in the interactions.

The effect of secular education in a theocracy (like, say, Afghanistan) can be simulated by changing the appropriate layer weights (less community/tribe, more thinking/planning). The benefits to that society can be estimated.

A firm with 8 partners may have issues of personality conflicts. The minds of the 8 partners can be represented using FIGS. 18, 20 and FIG. 22. The macro environment (economy, national politics) can be included among the stimuli. The simulation may indicate the effects of changing certain variables and help improve the working relationships among the partners.

The military may want to model its soldiers (using a representative sample of minds) and study the effects of specific training programs using simulation.

Religious figures claim that a single person becoming enlightened (that is, ego-less) can have a profound impact on the consciousness of all of humanity. A simulation of, say, one thousand minds can be used to study the situation when one of the minds suddenly gets transformed and starts acting primarily from the layer 7 (truth and openness to change).

A high school of 1,500 students can model its teenage student body (using a representative sample of, say, 75 students) and study the interactions. The impact of specific interventions (like student counseling sessions) can be simulated.

The impact of replacing a dictator in a despotic country with a democratic government can be simulated and forecasted.

Trends in society (changes in the Macro or Micro environments) can be simulated and forecasted.

Video games can be created using several personalities. Interactions among the personalities can be used for games/fun, and interesting screen icons and characters can be created.

Individuals can have their personalities (FIGS. 18 and 22) modeled on their cell phones and assume aliases (cell phones are rapidly expanding in their memory and processing power). The aliases can interact with other people's aliases in a virtual reality game.

Other examples too numerous to list here.

5.0 LOOKING AHEAD: The computer model and simulation is like a musical instrument that one needs to learn how to play and master. Research needs to be conducted on constructing personality tests that more accurately capture the human mind as represented in FIGS. 18, 20 and FIG. 22. Several emulation and simulation studies must be done, like the applications above (sec 4.0), to better understand the benefits and

limitations of simulations, as well as how to improve them. The processing algorithm (including feedback) needs to be refined. The human mind is incredibly complex and will defy perfect modeling. The goal should be to continually refine the model until better and better results are obtained.

6.0 SUMMARY: This invention broadly covers the idea of modeling the human mind, personality and ego using computers. It includes a layered model of the human mind that shows the animal, human, intellectual and spiritual dimensions. It deals with variations from mind to mind, and inconsistencies within a mind over time. The invention includes modeling the on-going modifications to the human mind based on external stimuli, insights, learning and conditioning. It also includes the idea of using the computer model for simulating a very wide variety of human interactions (among individuals and groups). Such simulations can be used to gain insights or forecast future interaction results. The invention further describes approaches, methods, algorithms, calculations and examples that are illustrative, not restrictive. Both deterministic (cause-effect) and probabilistic (based on chance) interactions are included in the invention. Within the broad scope and spirit of this invention, there is abundant room for improvements and refinements in assumptions, methods, algorithms, calculations, and techniques.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a personality test, comprising:
determining a set of mind layer attributes based on a library of categories;
analyzing a set of mind layer categories through at least one variable chosen from a group comprising a resistance to change variable and an intensity variable;
evaluating the mind layer categories through at least one of the set of layers; and
determining a variance of a category distribution of the set of layers.

2. The method of claim 1, further comprising:
generating a library of connotations which evolves based on a set of learnings, insights and thoughts;
developing a library of stimuli tagged to individual mind layer categories and an origin of stimuli based on the set of learnings;
mapping a stimulus to the layer and the origin through a random number generator; and
when the random number generator determines a value lower than a threshold value, routing data to a truth and openness layer data of a processing module.

3. The method of claim 2, wherein a response to stimulus factors are at least one of an insight, a learned training, an innate trait, an instinctual state, an instinct, a talent, and a skill.

4. The method of claim 1, further comprising generating the variance through an algorithm that considers any of a random selection and a relative probability of a particular event occurring.

5. The method of claim 1, further comprising generating a response to the stimulus having an intensity and resistance through at least one of a macro entity pegged to an individual factor and a micro entity pegged to a personal experience factor.

6. The method of claim 5 further comprising generating the response through an algorithm that considers at least one of a probabilistic and a deterministic response to the stimulus.

7. The method of claim 5, further comprising enhancing the stimulus through an addition of a factor determined by a user input.

8. The method of claim 7, further comprising:
matching the stimulus with a response; and
determining a connotation mapping and a connotation response mapping based on the stimulus, wherein responsive to the connotation response mapping of an individual, generating a response back to the individual, wherein responsive to the connotation response mapping of a micro entity including a family, a community and an association, generating a response back to the micro entity, and wherein responsive to the connotation response mapping of a macro entity including a geographic group, a social group and a civic body, generating a response back to the macro entity.

9. The method of claim 8, wherein an exception variable is provided of a stimulus from one entity response in a response to at least one of an individual, a micro entity and a macro entity.

10. The method of claim 9, further comprising generating a weighted score using a product of a layer weight and intensity through a computer simulation that generates a time period analysis of an effect of the stimuli having a summary of weighted responses that are at least one of a positive response and a negative response.

11. The method of claim 1, further comprising generating a change in a mind layer of the set of layers based on an insight gained, a knowledge gained, and a conditioning of an entity represented in the simulation.

12. The method of claim 11, further comprising transforming a response of the entity represented through an iterative process that considers weights, response intensities and connotations to future stimuli.

13. The method of claim 1, in a form of a machine-readable medium embodying a set of instructions that, when executed by a machine, causes the machine to perform the method of claim 1.

14. The method of claim 12, wherein the simulation is structured in a multi-layer model in which:
a highest layer comprises a truth attribute having a lack of ego connotation and a power of transformation of the various mind layers of the individual;
a layer adjacent to the highest layer is comprised of at least one of talents, skills, a knowledge acquisition and expanding an intellectual capacity of a mind through an increase of certain responses and intensities in that layer;
a set of other layers to modify the connotations of the mind through a resistance to a change which is incorporated through a threshold value; and
to allow the change to occur when the random number is greater than the resistance to change.

15. The method of claim 12, further comprising a seven layer model generated through questioning mind, aesthetic sense, openness to new insights, change, compassion, and empathy in one layer;
determining imagination, intuition, pattern recognition, memory, calculation, logic, music, math, and planning in another layer;
analyzing likes and dislikes, memories of pleasure and pain, physical attributes, opinions, biases, interests, and mental problems in yet another layer;
determining livelihood of profession, skills, position, economic status, education, money and investments, responsibilities, and authority in a further layer;
generating a community layer having a set of laws, hierarchy, role, do's and don'ts, ideology, politics, social status, rights and obligations in yet a further layer;
evaluating family and cultural bonds through an analysis of right and wrong, popular culture, religion, and beliefs in a next layer; and
determining gender, lust, greed, fear, fight, flight, anger, desires, cunning, and race in yet a next layer.

16. The method of claim 14, further comprising a series of responses and corresponding weighted scores of an individual mind, a group of minds, and a geographic region.

17. The method of claim 15, further comprising determining a set of patterns of experiences that at least one of the individual mind, the group of minds, and the geographic region is having.

18. The method of claim 16, wherein the set of patterns of experiences include at least one of a love variable, an anger variable, a revenge variable, an insight variable, and a compassion variable.

19. The method of claim 17, further comprising determining a preference of a particular item through the set of patterns of experiences shared with at least one other entity.

20. The method of claim 18, further comprising reporting a trace of all changes of the individual mind due to insights, learnings and conditionings.

21. The method of claim 19, further comprising:
a network of individual representations to form a group and society having one including a sample size based on statistical analysis to obtain a desired confidence level;
relying on a confidence level through the network of individual representations;
placing the network in a collective entity serving as a vessel of recording an aggregate effect of a set of responses of individual minds; and
calibrating a set of assumptions until a set of results of a simulation are validated through a reality-checking analysis.

22. An apparatus, comprising:
a mind module to determine a set of mind layer attributes based on a library of categories;
an assessment module to determine a set of mind layer categories through at least one variable chosen from a group comprising a resistance to change variable and an intensity variable;
an evaluation module to evaluate the mind layer categories through at least one of the set of layers; and
a variance module to determine a variance of a category distribution of the set of layers through an algorithm that considers a relative probability of any particular event occurring.

23. The apparatus of claim 22, further comprising:
a livelihood module to determine livelihood of profession, skills, position, economic status, education, money and investments, responsibilities, and authority in a further layer;
a community module to generate a set of laws, hierarchy, role, do's and don'ts, ideology, politics, social status, rights and obligations in yet a further layer.
a social hierarchy module to value family and cultural bonds through an analysis of right and wrong, popular culture, religion, and beliefs in a next layer; and
an emotion module to determine gender, lust, greed, fear, fight, flight, anger, desires, cunning, and race in yet a next layer.

24. A system comprising
a mind modeling module to generate a simulation of a mind structured in a multi-layer model in which:
a highest layer comprises a truth attribute having a lack of ego connotation and a power of transformation of various mind layers of an individual;
a layer adjacent to the highest layer is comprised of at least one of talents, skills, a knowledge acquisition and expanding an intellectual capacity of a mind through an increase of certain responses and intensities in that layer;
a set of other layers to modify the connotations of the mind through a resistance to a change which is incorporated through a threshold value; and
to allow the change to occur when the random number exceeds the resistance to change;
a network; and
a client module to
generate a stimulus through at least one of a macro entity pegged to an individual factor and a micro entity pegged to a personal experience factor;
match the stimulus with a response; and
determine a connotation mapping and a connotation response mapping based on the stimulus.

25. The system of claim 24, further comprising an instruction set to determine a set of patterns of experiences of an entity represented through an iterative process that considers weights, response intensities and connotations to future stimuli.

26. The system of claim 24, wherein the entity is at least one of an individual mind, a group of minds, a geographic group, a social group and a civic body, a nation and a global collective.
